(19) United States
(12) Patent Application Publication
(10) Pub. No.: US 2022/0334360 A1
(43) Pub. Date: Oct. 20, 2022

(54) OPTICAL LENS SYSTEM AND PHOTOGRAPHING MODULE

(71) Applicant: NEWMAX TECHNOLOGY CO., LTD., TAICHUNG CITY (TW)

(72) Inventor: Ching-Yun HUANG, TAICHUNG CITY (TW)

(21) Appl. No.: 17/376,171

(22) Filed: Jul. 15, 2021

(30) Foreign Application Priority Data
Apr. 14, 2021 (TW) 110113327

(51) Int. Cl. G02B 13/00; G02B 9/62; G03B 17/12; G02B 5/20; G02B 27/00

(52) U.S. Cl. CPC G02B 13/0045; G02B 9/62; G03B 17/12; G02B 5/208; G02B 27/0025

(57) ABSTRACT

An optical lens system includes, in order from the object side to the image side: a first lens, a second lens, a third lens, a fourth lens, a fifth lens, a sixth lens, an IR band-pass filter, wherein a stop is disposed before an object-side surface of the first lens or between an image-side surface of the first lens and an object-side surface of the second lens, a distance from the stop to an image plane along the optical axis is TSI, a distance from the object-side surface of the first lens to the image plane along the optical axis is TL, a distance from an image-side surface of the sixth lens to the image plane along the optical axis is BFL, a focal length of the optical lens system is f, following condition is satisfied: 0.25 mm⁻¹<TL/((TSI−BFL)*f)<0.49 mm⁻¹.

### BACKGROUND

### Field of the Invention

The present invention relates to an optical lens system and photographing module, and more particularly to an infrared optical lens system and infrared photographing module applicable to electronic products.

### Description of Related Art

In recent years, three dimensional (3D) sensing technology has been developing rapidly, especially in mobile phone applications. Nowadays, most of time of flight (TOF) photographing modules consist of four lenses. In the future, image sensor may need higher resolution and larger image size, so six-piece optical lens systems are needed to achieve better design.

In addition to be used in the field of infrared receiving and sensing of the game machine, in recent years, infrared optical lens system has also be used in mobile phones, and in order to improve the sensing effect, sensor with higher image resolution has become the mainstream for receiving infrared wavelength at present. Wherein the game machine has a longer photographing module length and lower resolution, so that the module size is too large or the accuracy is not good for mobile phones, which affects the recognition accuracy of image sensor.

The present invention mitigates and/or obviates the aforementioned disadvantages.

### SUMMARY

The primary objective of the present invention is to provide an optical lens system and photographing module. When a specific condition is satisfied, the optical lens system of the present invention can satisfy the objective of miniaturization and improve the image quality.

Therefore, an optical lens system in accordance with the present invention comprises, in order from an object side to an image side: a first lens with refractive power, comprising an object-side surface and an image-side surface, the object-side surface of the first lens being convex near an optical axis, and at least one of the object-side surface and the image-side surface of the first lens being aspheric; a second lens with refractive power, comprising an object-side surface and an image-side surface, and at least one of the object-side surface and the image-side surface of the second lens being aspheric; a third lens with refractive power, comprising an object-side surface and an image-side surface, and at least one of the object-side surface and the image-side surface of the third lens being aspheric; a fourth lens with refractive power, comprising an object-side surface and an image-side surface, and at least one of the object-side surface and the image-side surface of the fourth lens being aspheric; a fifth lens with refractive power, comprising an object-side surface and an image-side surface, and at least one of the object-side surface and the image-side surface of the fifth lens being aspheric; a sixth lens with refractive power, comprising an object-side surface and an image-side surface, the object-side surface of the sixth lens being convex near the optical axis and the image-side surface of the sixth lens being concave near the optical axis, and at least one of the object-side surface and the image-side surface of the sixth lens being aspheric and provided with an inflection point; and an IR band-pass filter.

Wherein a stop is located before the object-side surface of the first lens or between the image-side surface of the first lens and the object-side surface of the second lens, a distance from the stop to an image plane along the optical axis is TSI, a distance from the object-side surface of the first lens to the image plane along the optical axis is TL, a distance from the image-side surface of the sixth lens to the image plane along the optical axis is BFL, a focal length of the optical lens system is f, and following condition is satisfied: 0.25 mm⁻¹<TL/((TSI−BFL)*f)<0.49 mm⁻¹.

Preferably, the optical lens system has a total of six lenses with refractive power.

The present invention has the following effect: if the above six lenses with refractive power satisfy the condition 0.25 mm⁻¹<TL/((TSI−BFL)*f)<0.49 mm⁻¹, it is favorable to meet the requirement of miniaturization of the lens system and maintain better performance. Preferably, following condition can be satisfied: 0.28 mm⁻¹<TL/((TSI−BFL)*f)<0.47 mm⁻¹.

Preferably, a focal length of the third lens is f3, a focal length of the fourth lens is f4, and following condition is satisfied: −1.93<f3/f4<0.62, so that the distribution of the refractive power of the lens system will be appropriate, it will be favorable to correct the aberration of the lens system and improve the image quality. Preferably, following condition can be satisfied: −1.77<f3/f4<0.57.

Preferably, a focal length of the first lens is f1, a radius of curvature of the object-side surface of the first lens is R1, and following condition is satisfied: −10.53<f1/R1<3.62, so that the ratio of the curvature of the object-side surface of the first lens to the refractive power of the first lens can provide a suitable field of view and maintain the image quality of the lens system. Preferably, following condition can be satisfied: −9.65<f1/R1<3.32.

Preferably, the focal length of the first lens is f1, the focal length of the optical lens system is f, and following condition is satisfied: −8.16<f1/f<2.15, so as to reduce the assembly sensitivity of the first lens. Preferably, following condition can be satisfied: −7.48<f1/f<1.98.

Preferably, a radius of curvature of the object-side surface of the third lens is R5, a radius of curvature of the image-side surface of the third lens is R6, and following condition is satisfied: −0.66<R5/R6<1.18, which makes the third lens has the optimum refractive power. Preferably, following condition can be satisfied: −0.61<R5/R6<1.08.

Preferably, a central thickness of the fifth lens along the optical axis is CT5, a radius of curvature of the object-side surface of the fifth lens is R9, a radius of curvature of the image-side surface of the fifth lens is R10, and following condition is satisfied: −15.9 mm<CT5*(R9/R10)<1.81 mm, which can adjust the lens thickness and the radius of curvature, so as to reduce the effect of manufacturing tolerance on image quality. Preferably, following condition can be satisfied: −14.58 mm<CT5*(R9/R10)<1.66 mm.

Preferably, the distance from the object-side surface of the first lens to the image plane along the optical axis is TL, the focal length of the optical lens system is f, and following condition is satisfied: 1.11<TL/f<1.88, which ensures that the lens system has sufficient refractive power to shorten the length of the lens system. Preferably, following condition can be satisfied: 1.25<TL/f<1.72.

Preferably, the distance from the image-side surface of the sixth lens to the image plane along the optical axis is BFL, the distance from the object-side surface of the first lens to the image plane along the optical axis is TL, and following condition is satisfied: 0.15<BFL/TL<0.33, which is favorable to achieve a proper balance between miniaturization and the back focal length. Preferably, following condition can be satisfied: 0.17<BFL/TL<0.30.

Preferably, a radius of curvature of the object-side surface of the fourth lens is R7, a radius of curvature of the image-side surface of the fourth lens is R8, and following condition is satisfied: 0.10<R7/R8<1.44, which can reduce the spherical aberration and astigmatism effectively. Preferably, following condition can be satisfied: 0.12<R7/R8<1.32.

Preferably, the focal length of the optical lens system is f, a radius of curvature of the image-side surface of the sixth lens is R12, a central thickness of the third lens along the optical axis is CT3, and following condition is satisfied: 3.88 mm⁻¹<f/(R12*CT3)<10.89 mm⁻¹, which can improve the image quality of the lens system. Preferably, following condition can be satisfied: 4.37 mm⁻¹<f/(R12*CT3)<9.98 mm⁻¹.

Preferably, a central thickness of the sixth lens along the optical axis is CT6, the radius of curvature of the image-side surface of the sixth lens is R12, and following condition is satisfied: 0.27<CT6/R12<0.74, which can reduce the ghost image. Preferably, following condition can be satisfied: 0.30<CT6/R12<0.68.

A photographing module in accordance with the present invention comprises the above optical lens system, a lens barrel for accommodating the optical lens system, and an image sensor disposed on the image plane of the optical lens system.

Another photographing module in accordance with the present invention comprises an optical lens system, a lens barrel for accommodating the optical lens system, and an image sensor disposed on an image plane of the optical lens system.

Wherein the optical lens system comprises, in order from an object side to an image side: a first lens with refractive power, comprising an object-side surface and an image-side surface, the object-side surface of the first lens being convex near an optical axis, and at least one of the object-side surface and the image-side surface of the first lens being aspheric; a second lens with refractive power, comprising an object-side surface and an image-side surface, and at least one of the object-side surface and the image-side surface of the second lens being aspheric; a third lens with refractive power, comprising an object-side surface and an image-side surface, and at least one of the object-side surface and the image-side surface of the third lens being aspheric; a fourth lens with refractive power, comprising an object-side surface and an image-side surface, and at least one of the object-side surface and the image-side surface of the fourth lens being aspheric; a fifth lens with refractive power, comprising an object-side surface and an image-side surface, and at least one of the object-side surface and the image-side surface of the fifth lens being aspheric; a sixth lens with refractive power, comprising an object-side surface and an image-side surface, the object-side surface of the sixth lens being convex near the optical axis and the image-side surface of the sixth lens being concave near the optical axis, and at least one of the object-side surface and the image-side surface of the sixth lens being aspheric and provided with an inflection point; and an IR band-pass filter.

Wherein a distance from the object-side surface of the first lens to the image plane along the optical axis is TL, half of an image height that can be captured by the optical lens system on the image plane is IMH, and following condition is satisfied: 1.4<TL/IMH<2.37, which can achieve the optimum length of the lens system and image size. Preferably, following condition can be satisfied: 1.58<TL/IMH<2.17.

Preferably, the optical lens system has a total of six lenses with refractive power.

Preferably, a distance from a stop to the image plane along the optical axis is TSI, the distance from the object-side surface of the first lens to the image plane along the optical axis is TL, a distance from the image-side surface of the sixth lens to the image plane along the optical axis is BFL, a focal length of the optical lens system is f, and following condition is satisfied: 0.25 mm⁻¹<TL/((TSI−BFL)*f)<0.49 mm⁻¹, it is favorable to meet the requirement of miniaturization of the lens system and maintain better performance. Preferably, following condition can be satisfied: 0.28 mm⁻¹<TL/((TSI−BFL)*f)<0.47 mm⁻¹.

Preferably, a focal length of the first lens is f1, the focal length of the optical lens system is f, and following condition is satisfied: −8.16<f1/f<2.15, so as to reduce the assembly sensitivity of the first lens. Preferably, following condition can be satisfied: −7.48<f1/f<1.98.

Preferably, a focal length of the third lens is f3, a focal length of the fourth lens is f4, and following condition is satisfied: −1.93<f3/f4<0.62, so that the distribution of the refractive power of the lens system will be appropriate, it will be favorable to correct the aberration of the lens system and improve the image quality. Preferably, following condition can be satisfied: −1.77<f3/f4<0.57.

Preferably, the focal length of the first lens is f1, a radius of curvature of the object-side surface of the first lens is R1, and following condition is satisfied: −10.53<f1/R1<3.62, so that the ratio of the curvature of the object-side surface of the first lens to the refractive power of the first lens can provide a suitable field of view and maintain the image quality of the lens system. Preferably, following condition can be satisfied: −9.65<f1/R1<3.32.

Preferably, a radius of curvature of the object-side surface of the third lens is R5, a radius of curvature of the image-side surface of the third lens is R6, and following condition is satisfied: −0.66<R5/R6<1.18, which makes the third lens has the optimum refractive power. Preferably, following condition can be satisfied: −0.61<R5/R6<1.08.

Preferably, a central thickness of the fifth lens along the optical axis is CT5, a radius of curvature of the object-side surface of the fifth lens is R9, a radius of curvature of the image-side surface of the fifth lens is R10, and following condition is satisfied: −15.9 mm<CT5*(R9/R10)<1.81 mm, which can adjust the lens thickness and the radius of curvature, so as to reduce the effect of manufacturing tolerance on image quality. Preferably, following condition can be satisfied: −14.58 mm<CT5*(R9/R10)<1.66 mm.

Preferably, the distance from the object-side surface of the first lens to the image plane along the optical axis is TL, the focal length of the optical lens system is f, and following condition is satisfied: 1.11<TL/f<1.88, which ensures that the lens system has sufficient refractive power to shorten the length of the lens system. Preferably, following condition can be satisfied: 1.25<TL/f<1.72.

Preferably, the distance from the image-side surface of the sixth lens to the image plane along the optical axis is BFL, the distance from the object-side surface of the first lens to the image plane along the optical axis is TL, and following condition is satisfied: 0.15<BFL/TL<0.33, which is favorable to achieve a proper balance between miniaturization and the back focal length. Preferably, following condition can be satisfied: 0.17<BFL/TL<0.30.

Preferably, a radius of curvature of the object-side surface of the fourth lens is R7, a radius of curvature of the image-side surface of the fourth lens is R8, and following condition is satisfied: 0.10<R7/R8<1.44, which can reduce the spherical aberration and astigmatism effectively. Preferably, following condition can be satisfied: 0.12<R7/R8<1.32.

Preferably, the focal length of the optical lens system is f, a radius of curvature of the image-side surface of the sixth lens is R12, a central thickness of the third lens along the optical axis is CT3, and following condition is satisfied: 3.88 mm⁻¹<f/(R12*CT3)<10.89 mm⁻¹, which can improve the image quality of the lens system. Preferably, following condition can be satisfied: 4.37 mm⁻¹<f/(R12*CT3)<9.98 mm⁻¹.

Preferably, a central thickness of the sixth lens along the optical axis is CT6, the radius of curvature of the image-side surface of the sixth lens is R12, and following condition is satisfied: 0.27<CT6/R12<0.74, which can reduce the ghost image. Preferably, following condition can be satisfied: 0.30<CT6/R12<0.68.

For each of the above optical lens systems or the photographing modules, wherein the focal length of the optical lens system is f, and following condition is satisfied: 3.12 mm<f<4.60 mm Preferably, following condition can be satisfied: 3.30 mm<f<4.39 mm.

For each of the above optical lens systems or the photographing modules, a f-number of the optical lens system is Fno, and following condition is satisfied: 1.08<Fno<1.65. Preferably, following condition can be satisfied: 1.14<Fno<1.58.

For each of the above optical lens systems or the photographing modules, the optical lens system has a maximum view angle (field of view) FOV, and following condition is satisfied: 67.5 degrees<FOV<88.66 degrees. Preferably, following condition can be satisfied: 71.25 degrees<FOV<84.3 degrees.

For each of the above optical lens systems or the photographing modules, an incident pupil aperture of the optical lens system is EPD, and following condition is satisfied: 2.33<EPD<3.81. Preferably, following condition can be satisfied: 2.46<EPD<3.64.

For each of the above optical lens systems or the photographing modules, the focal length of the first lens is f1, a focal length of the second lens, the third lens, the fourth lens, the fifth lens and the sixth lens combined is f23456, and following condition is satisfied: −9.66<f1/f23456<1.15, so that the distribution of the refractive power of the system will be appropriate, it will be favorable to correct the aberration of the system and improve the image quality. Preferably, following condition can be satisfied: −8.86<f1/f23456<1.06.

For each of the above optical lens systems or the photographing modules, a focal length of the second lens and the third lens combined is f23, a focal length of the fourth lens and the fifth lens combined is f45, and following condition is satisfied: −6.26<f23/f45<8.09, so that the distribution of the refractive power of the system will be appropriate, it will be favorable to correct the aberration of the system and improve the image quality. Preferably, following condition can be satisfied: −5.73<f23/f45<7.41.

The present invention will be presented in further details from the following descriptions with the accompanying drawings, which show, for purpose of illustrations only, the preferred embodiments in accordance with the present invention.

### BRIEF DESCRIPTION OF THE DRAWINGS

FIG. 1A shows an optical lens system in accordance with a first embodiment of the present invention;

FIG. 1B shows the image plane curve and the distortion curve of the first embodiment of the present invention;

FIG. 2A shows an optical lens system in accordance with a second embodiment of the present invention;

FIG. 2B shows the image plane curve and the distortion curve of the second embodiment of the present invention;

FIG. 3A shows an optical lens system in accordance with a third embodiment of the present invention;

FIG. 3B shows the image plane curve and the distortion curve of the third embodiment of the present invention;

FIG. 4A shows an optical lens system in accordance with a fourth embodiment of the present invention;

FIG. 4B shows the image plane curve and the distortion curve of the fourth embodiment of the present invention;

FIG. 5A shows an optical lens system in accordance with a fifth embodiment of the present invention;

FIG. 5B shows the image plane curve and the distortion curve of the fifth embodiment of the present invention;

FIG. 6A shows an optical lens system in accordance with a sixth embodiment of the present invention;

FIG. 6B shows the image plane curve and the distortion curve of the sixth embodiment of the present invention; and

FIG. 7 shows a photographing module in accordance with a seventh embodiment of the present invention.

### DETAILED DESCRIPTION

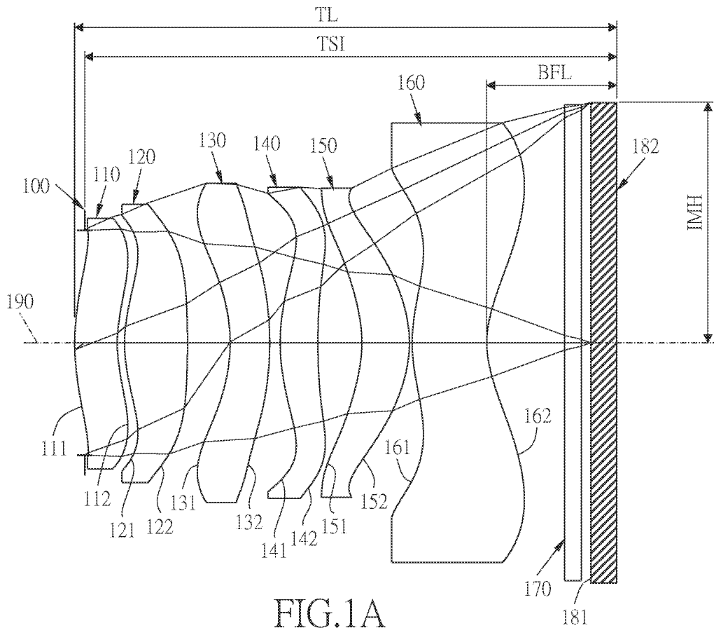

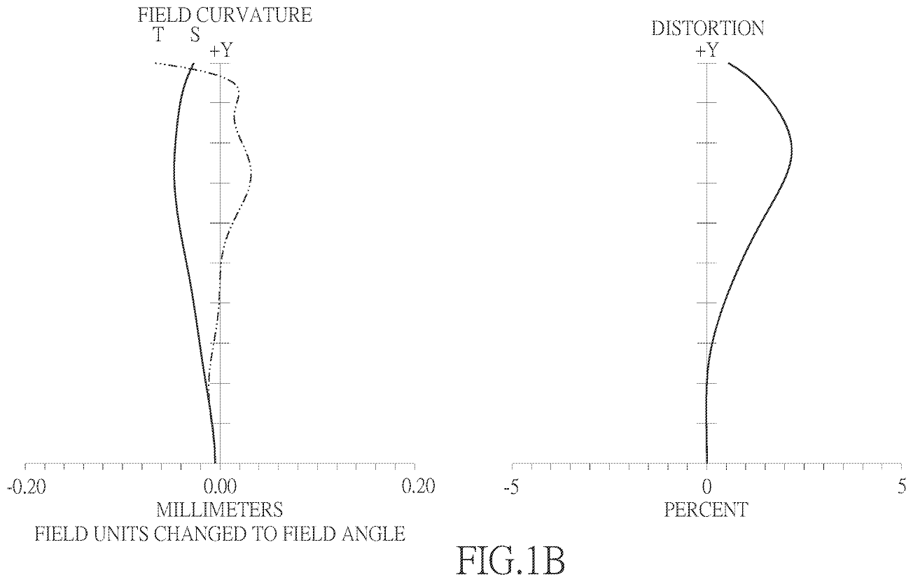

Referring to FIGS. 1A and 1B, FIG. 1A shows an optical lens system in accordance with a first embodiment of the present invention, and FIG. 1B shows, in order from left to right, the image plane curve and the distortion curve of the first embodiment of the present invention. An optical lens system in accordance with the first embodiment of the present invention comprises a stop 100 and a lens group. The optical lens system is provided with an image sensor 182. The lens group comprises, in order from an object side to an image side along an optical axis 190: a first lens 110, a second lens 120, a third lens 130, a fourth lens 140, a fifth lens 150, a sixth lens 160, an IR band-pass filter 170, and an image plane 181, wherein the optical lens system has a total of six lenses with refractive power, but not limited to this. The stop 100 is disposed between an object and the first lens 110. The image sensor 182 is disposed on the image plane 181.

The first lens 110 with negative refractive power, comprising an object-side surface 111 and an image-side surface 112, the object-side surface 111 of the first lens 110 being convex near the optical axis 190 and the image-side surface 112 of the first lens 110 being concave near the optical axis 190, the object-side surface 111 and the image-side surface 112 of the first lens 110 are aspheric, and the first lens 110 is made of plastic material.

The second lens 120 with positive refractive power, comprising an object-side surface 121 and an image-side surface 122, the object-side surface 121 of the second lens 120 being convex near the optical axis 190 and the image-side surface 122 of the second lens 120 being convex near the optical axis 190, the object-side surface 121 and the image-side surface 122 of the second lens 120 are aspheric, and the second lens 120 is made of plastic material.

The third lens 130 with negative refractive power, comprising an object-side surface 131 and an image-side surface 132, the object-side surface 131 of the third lens 130 being concave near the optical axis 190 and the image-side surface 132 of the third lens 130 being convex near the optical axis 190, the object-side surface 131 and the image-side surface 132 of the third lens 130 are aspheric, and the third lens 130 is made of plastic material.

The fourth lens 140 with positive refractive power, comprising an object-side surface 141 and an image-side surface 142, the object-side surface 141 of the fourth lens 140 being convex near the optical axis 190 and the image-side surface 142 of the fourth lens 140 being concave near the optical axis 190, the object-side surface 141 and the image-side surface 142 of the fourth lens 140 are aspheric, and the fourth lens 140 is made of plastic material.

The fifth lens 150 with positive refractive power, comprising an object-side surface 151 and an image-side surface 152, the object-side surface 151 of the fifth lens 150 being concave near the optical axis 190 and the image-side surface 152 of the fifth lens 150 being convex near the optical axis 190, the object-side surface 151 and the image-side surface 152 of the fifth lens 150 are aspheric, and the fifth lens 150 is made of plastic material.

The sixth lens 160 with negative refractive power, comprising an object-side surface 161 and an image-side surface 162, the object-side surface 161 of the sixth lens 160 being convex near the optical axis 190 and the image-side surface 162 of the sixth lens 160 being concave near the optical axis 190, the object-side surface 161 and the image-side surface 162 of the sixth lens 160 are aspheric and are provided with at least one inflection point, and the sixth lens 160 is made of plastic material.

The IR band-pass filter 170 made of glass is located between the sixth lens 160 and the image plane 181 and has no influence on the focal length of the optical lens system. The present embodiment selects a filter which is available in the light wavelength range of 940 nm±30 nm, but not limited to this.

The equation for the aspheric surface profiles of the respective lenses of the first embodiment is expressed as follows:

$$z = \frac{{ch}^{2}}{1 + {[ 1 - ( k + 1 ) {c}^{2} {h}^{2} ]}^{0.5}} + {Ah}^{4} + {Bh}^{6} + {Ch}^{8} + D {h}^{10} + {Eh}^{12} + {Fh}^{14} + {Gh}^{16} …$$

wherein:

z represents the value of a reference position with respect to a vertex of the surface of a lens and a position with a height h along the optical axis 190;

c represents a paraxial curvature equal to 1/R (R: a paraxial radius of curvature);

h represents a vertical distance from the point on the curve of the aspheric surface to the optical axis 190;

k represents the conic constant;

A, B, C, D, E, F, G, . . . represent the high-order aspheric coefficients.

In the first embodiment of the present optical lens system, a focal length of the optical lens system is f, a f-number of the optical lens system is Fno, the optical lens system has a maximum view angle FOV, and following conditions are satisfied: f=4.16 mm; Fno=1.35; and FOV=76.1 degrees.

In the first embodiment of the present optical lens system, a distance from the stop 100 to the image plane 181 along the optical axis 190 is TSI, a distance from the object-side surface 111 of the first lens 110 to the image plane 181 along the optical axis 190 is TL, a distance from the image-side surface 162 of the sixth lens 160 to the image plane 181 along the optical axis 190 is BFL, a focal length of the optical lens system is f, and following condition is satisfied: TL/((TSI−BFL)*f)=0.31 mm⁻¹.

In the first embodiment of the present optical lens system, a focal length of the third lens 130 is f3, a focal length of the fourth lens 140 is f4, and following condition is satisfied: f3/f4=−1.27.

In the first embodiment of the present optical lens system, a focal length of the first lens 110 is f1, a radius of curvature of the object-side surface 111 of the first lens 110 is R1, and following condition is satisfied: f1/R1=−3.20.

In the first embodiment of the present optical lens system, the focal length of the first lens 110 is f1, the focal length of the optical lens system is f, and following condition is satisfied: f1/f=−2.83.

In the first embodiment of the present optical lens system, a radius of curvature of the object-side surface 131 of the third lens 130 is R5, a radius of curvature of the image-side surface 132 of the third lens 130 is R6, and following condition is satisfied: R5/R6=0.48.

In the first embodiment of the present optical lens system, a central thickness of the fifth lens 150 along the optical axis 190 is CT5, a radius of curvature of the object-side surface 151 of the fifth lens 150 is R9, a radius of curvature of the image-side surface 152 of the fifth lens 150 is R10, and following condition is satisfied: CT5*(R9/R10)=0.65 mm.

In the first embodiment of the present optical lens system, the distance from the object-side surface 111 of the first lens 110 to the image plane 181 along the optical axis 190 is TL, the focal length of the optical lens system is f, and following condition is satisfied: TL/f=1.57.

In the first embodiment of the present optical lens system, the distance from the image-side surface 162 of the sixth lens 160 to the image plane 181 along the optical axis 190 is BFL, the distance from the object-side surface 111 of the first lens 110 to the image plane 181 along the optical axis 190 is TL, and following condition is satisfied: BFL/TL=0.20.

In the first embodiment of the present optical lens system, a radius of curvature of the object-side surface 141 of the fourth lens 140 is R7, a radius of curvature of the image-side surface 142 of the fourth lens 140 is R8, and following condition is satisfied: R7/R8=0.26.

In the first embodiment of the present optical lens system, the focal length of the optical lens system is f, a radius of curvature of the image-side surface 162 of the sixth lens 160 is R12, a central thickness of the third lens 130 along the optical axis 190 is CT3, and following condition is satisfied: f/(R12*CT3)=5.46 mm⁻¹.

In the first embodiment of the present optical lens system, a central thickness of the sixth lens 160 along the optical axis 190 is CT6, the radius of curvature of the image-side surface 162 of the sixth lens 160 is R12, and following condition is satisfied: CT6/R12=0.62.

In the first embodiment of the present optical lens system, the distance from the object-side surface 111 of the first lens 110 to the image plane 181 along the optical axis 190 is TL, half of an image height that can be captured by the optical lens system on the image plane 181 is IMH, and following condition is satisfied: TL/IMH=1.98.

In the first embodiment of the present optical lens system, the focal length of the first lens 110 is f1, a focal length of the second lens, the third lens, the fourth lens, the fifth lens and the sixth lens combined is f23456, and following condition is satisfied: f1/f23456=−4.02.

In the first embodiment of the present optical lens system, a focal length of the second lens 120 and the third lens 130 combined is f23, a focal length of the fourth lens 140 and the fifth lens 150 combined is f45, and following condition is satisfied: f23/f45=0.88.

The detailed optical data of the first embodiment is shown in table 1, and the aspheric surface data is shown in table 2.

TABLE 1
Embodiment 1
f(focal length) = 4.16 mm, Fno = 1.35, FOV = 76.1 deg.

| | | Curvature | | Thickness/ | | | Abbe | Focal |
|---|---|---|---|---|---|---|---|---|
| surface | | Radius | | gap | Material | Index(nd) | #(vd) | length |
| 0 | object | infinity | | 700.000 | | | | |
| 1 | stop | infinity | | −0.125 | | | | |
| 2 | Lens 1 | 3.680 | (ASP) | 0.537 | plastic | 1.64 | 22.5 | −11.78 |
| 3 | | 2.312 | (ASP) | 0.091 | | | | |
| 4 | Lens 2 | 2.289 | (ASP) | 0.796 | plastic | 1.64 | 22.5 | 3.26 |
| 5 | | −15.069 | (ASP) | 0.542 | | | | |
| 6 | Lens 3 | −2.520 | (ASP) | 0.500 | plastic | 1.64 | 22.5 | −8.33 |
| 7 | | −5.284 | (ASP) | 0.132 | | | | |
| 8 | Lens 4 | 3.067 | (ASP) | 0.477 | plastic | 1.64 | 22.5 | 6.58 |
| 9 | | 11.592 | (ASP) | 0.557 | | | | |
| 10 | Lens 5 | −2.023 | (ASP) | 0.600 | plastic | 1.64 | 22.5 | 15.84 |
| 11 | | −1.869 | (ASP) | 0.035 | | | | |
| 12 | Lens 6 | 2.409 | (ASP) | 0.941 | plastic | 1.64 | 22.5 | −11.32 |
| 13 | | 1.526 | (ASP) | 0.987 | | | | |

| | | | | | | |
|---|---|---|---|---|---|---|
| 14 | IR | infinity | 0.210 | glass | 1.52 | 64.2 |
| | band-pass | | | | | |
| | filter | | | | | |
| 15 | | infinity | 0.118 | | | |
| 16 | Image plane | infinity | — | | | |

Note:
reference wavelength is 940 nm

TABLE 2
Aspheric Coefficients

| surface | 2 | 3 | 4 | 5 | 6 | 7 |
|---|---|---|---|---|---|---|
| K: | −1.0210E+01 | −9.5009E+00 | −7.6591E+00 | 2.4860E+01 | 6.5473E−02 | −6.3437E+00 |
| A: | −8.1072E−03 | −3.3255E−02 | −1.4051E−02 | −1.3959E−02 | 1.1973E−02 | −2.9985E−02 |
| B: | 5.4994E−03 | −6.1327E−03 | −9.7572E−03 | −7.6677E−03 | −1.8031E−03 | 9.9731E−03 |
| C: | −6.5812E−03 | −3.0071E−04 | −1.4033E−03 | 5.0878E−04 | 4.6438E−03 | 8.1398E−04 |
| D: | 2.0960E−03 | 1.5899E−04 | 9.7934E−05 | 1.3677E−04 | −3.4696E−04 | −2.8401E−04 |
| E: | −2.9030E−04 | 1.7817E−04 | 6.9509E−05 | −3.9645E−06 | −1.7272E−04 | −9.3987E−05 |
| F: | −1.3681E−05 | −5.3643E−05 | 6.0460E−06 | 4.1257E−06 | 2.8561E−05 | 1.7151E−05 |
| G: | 0.0000E+00 | 0.0000E+00 | 0.0000E+00 | 0.0000E+00 | −7.1819E−07 | −8.0095E−08 |
| surface | 8 | 9 | 10 | 11 | 12 | 13 |
| K: | −7.4437E+00 | 2.6036E+01 | −9.6040E+00 | −4.5252E+00 | −5.1778E+00 | −4.3112E+00 |
| A: | 1.2598E−02 | 3.4185E−02 | −5.6647E−03 | −2.4313E−02 | −6.3956E−02 | −2.7041E−02 |
| B: | −1.1899E−02 | −1.9032E−02 | −5.6107E−03 | 2.2982E−03 | 1.1050E−02 | 4.0055E−03 |
| C: | −4.1719E−04 | −2.3926E−04 | 1.5778E−03 | −9.5630E−04 | −1.3934E−03 | −2.0475E−04 |
| D: | −1.8948E−05 | 4.7154E−04 | 8.8003E−05 | 4.3442E−04 | −5.4623E−05 | −7.9400E−05 |
| E: | −2.7808E−05 | −2.0143E−05 | 9.4915E−06 | 8.4869E−06 | 2.7029E−05 | 1.7092E−05 |
| F: | 1.8417E−05 | −1.5678E−06 | −1.7085E−06 | −7.9485E−06 | 1.6344E−06 | −1.3688E−06 |
| G: | −7.2504E−07 | −6.6423E−08 | −1.1135E−06 | 5.1897E−07 | −3.5580E−07 | 4.0192E−08 |

The units of the radius of curvature, the thickness and the focal length in table 1 are expressed in mm, the surface numbers 0-12 represent the surfaces sequentially arranged from the object-side to the image-side along the optical axis, wherein surface 0 represents a gap between the object and the stop 100 along the optical axis 190, surface 1 represents a gap between the stop 100 and the object-side surface 111 of the first lens 110 along the optical axis 190, the stop 100 is farther away from the object-side than the object-side surface 111 of the first lens 110, so it is expressed as a negative value, surfaces 2, 4, 6, 8, 10, 12, 14 are thicknesses of the first lens 110, the second lens 120, the third lens 130, the fourth lens 140, the fifth lens 150, the sixth lens 160, and the IR band-pass filter 170 along the optical axis 190, respectively, surface 3 represents a gap between the first lens 110 and the second lens 120 along the optical axis 190, surface 5 represents a gap between the second lens 120 and the third lens 130 along the optical axis 190, surface 7 represents a gap between the third lens 130 and the fourth lens 140 along the optical axis 190, surface 9 represents a gap between the fourth lens 140 and the fifth lens 150 along the optical axis 190, surface 11 represents a gap between the fifth lens 150 and the sixth lens 160 along the optical axis 190, surface 13 represents a gap between the sixth lens 160 and the IR band-pass filter 170 along the optical axis 190, surface 15 represents a gap between the IR band-pass filter 170 and the image plane 181 along the optical axis 190.

In table 2, k represents the conic coefficient of the equation of the aspheric surface profiles, and A, B, C, D, E, F, G . . . : represent the high-order aspheric coefficients. The tables presented below for each embodiment are the corresponding schematic parameter and image plane curves, and the definitions of the tables are the same as Table 1 and Table 2 of the first embodiment. Therefore, an explanation in this regard will not be provided again.

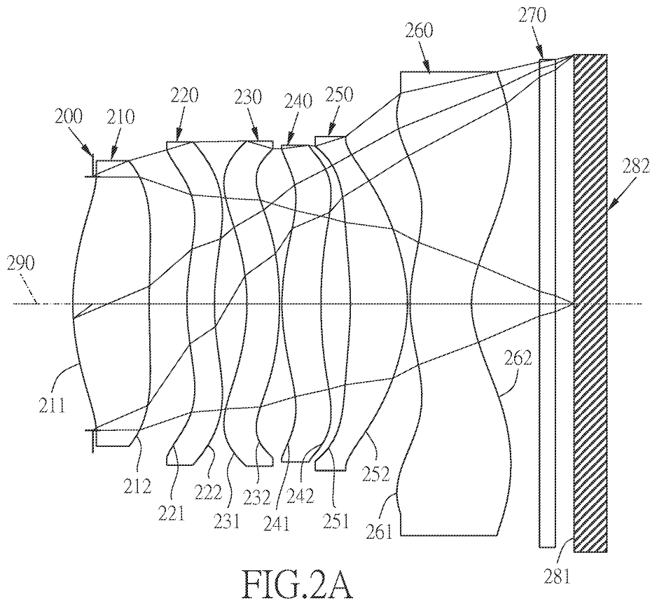

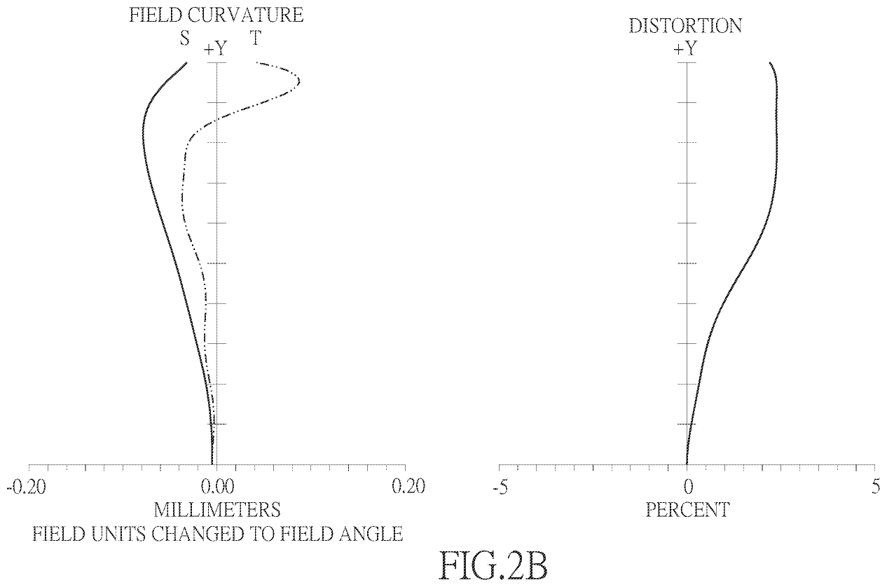

Referring to FIGS. 2A and 2B, FIG. 2A shows an optical lens system in accordance with a second embodiment of the present invention, and FIG. 2B shows, in order from left to right, the image plane curve and the distortion curve of the second embodiment of the present invention. An optical lens system in accordance with the second embodiment of the present invention comprises a stop 200 and a lens group. The optical lens system is provided with an image sensor 282. The lens group comprises, in order from an object side to an image side along an optical axis 290: a first lens 210, a second lens 220, a third lens 230, a fourth lens 240, a fifth lens 250, a sixth lens 260, an IR band-pass filter 270, and an image plane 281, wherein the optical lens system has a total of six lenses with refractive power, but not limited to this. The stop 200 is disposed between an object and the first lens 210. The image sensor 282 is disposed on the image plane 281.

The first lens 210 with positive refractive power, comprising an object-side surface 211 and an image-side surface 212, the object-side surface 211 of the first lens 210 being convex near the optical axis 290 and the image-side surface 212 of the first lens 210 being concave near the optical axis 290, the object-side surface 211 and the image-side surface 212 of the first lens 210 are aspheric, and the first lens 210 is made of plastic material.

The second lens 220 with positive refractive power, comprising an object-side surface 221 and an image-side surface 222, the object-side surface 221 of the second lens 220 being convex near the optical axis 290 and the image-side surface 222 of the second lens 220 being concave near the optical axis 290, the object-side surface 221 and the image-side surface 222 of the second lens 220 are aspheric, and the second lens 220 is made of plastic material.

The third lens 230 with negative refractive power, comprising an object-side surface 231 and an image-side surface 232, the object-side surface 231 of the third lens 230 being concave near the optical axis 290 and the image-side surface 232 of the third lens 230 being convex near the optical axis 290, the object-side surface 231 and the image-side surface 232 of the third lens 230 are aspheric, and the third lens 230 is made of plastic material.

The fourth lens 240 with positive refractive power, comprising an object-side surface 241 and an image-side surface 242, the object-side surface 241 of the fourth lens 240 being convex near the optical axis 290 and the image-side surface 242 of the fourth lens 240 being concave near the optical axis 290, the object-side surface 241 and the image-side surface 242 of the fourth lens 240 are aspheric, and the fourth lens 240 is made of plastic material.

The fifth lens 250 with positive refractive power, comprising an object-side surface 251 and an image-side surface 252, the object-side surface 251 of the fifth lens 250 being concave near the optical axis 290 and the image-side surface 252 of the fifth lens 250 being convex near the optical axis 290, the object-side surface 251 and the image-side surface 252 of the fifth lens 250 are aspheric, and the fifth lens 250 is made of plastic material.

The sixth lens 260 with negative refractive power, comprising an object-side surface 261 and an image-side surface 262, the object-side surface 261 of the sixth lens 260 being convex near the optical axis 290 and the image-side surface 262 of the sixth lens 260 being concave near the optical axis 290, the object-side surface 261 and the image-side surface 262 of the sixth lens 260 are aspheric and are provided with at least one inflection point, and the sixth lens 260 is made of plastic material.

The IR band-pass filter 270 made of glass is located between the sixth lens 260 and the image plane 281 and has no influence on the focal length of the optical lens system. The present embodiment selects a filter which is available in the light wavelength range of 940 nm±30 nm, but not limited to this.

The detailed optical data of the second embodiment is shown in table 3, and the aspheric surface data is shown in table 4.

TABLE 3
Embodiment 2
f(focal length) = 4.18 mm, Fno = 1.20, FOV = 76.7 deg.

| | | Curvature | | Thickness/ | | | Abbe | Focal |
|---|---|---|---|---|---|---|---|---|
| surface | | Radius | | gap | Material | Index(nd) | #(vd) | length |
| 0 | object | infinity | | 1000.000 | | | | |
| 1 | stop | infinity | | −0.264 | | | | |
| 2 | Lens 1 | 3.511 | (ASP) | 1.001 | plastic | 1.64 | 22.5 | 7.51 |
| 3 | | 12.662 | (ASP) | 0.491 | | | | |
| 4 | Lens 2 | 3.537 | (ASP) | 0.360 | plastic | 1.64 | 22.5 | 39.08 |
| 5 | | 3.979 | (ASP) | 0.425 | | | | |
| 6 | Lens 3 | −3.081 | (ASP) | 0.425 | plastic | 1.64 | 22.5 | −13.47 |
| 7 | | −5.136 | (ASP) | 0.034 | | | | |
| 8 | Lens 4 | 3.363 | (ASP) | 0.508 | plastic | 1.64 | 22.5 | 8.39 |
| 9 | | 8.929 | (ASP) | 0.383 | | | | |
| 10 | Lens 5 | −4.758 | (ASP) | 0.746 | plastic | 1.64 | 22.5 | 6.70 |
| 11 | | −2.353 | (ASP) | 0.035 | | | | |
| 12 | Lens 6 | 2.334 | (ASP) | 0.804 | plastic | 1.64 | 22.5 | −7.95 |
| 13 | | 1.376 | (ASP) | 0.887 | | | | |

| | | | | | | |
|---|---|---|---|---|---|---|
| 14 | IR | infinity | 0.210 | glass | 1.52 | 64.2 |
| | band-pass | | | | | |
| | filter | | | | | |
| 15 | | infinity | 0.242 | | | |
| 16 | Image plane | infinity | — | | | |

Note:
reference wavelength is 940 nm

TABLE 4
Aspheric Coefficients

| surface | 2 | 3 | 4 | 5 | 6 | 7 |
|---|---|---|---|---|---|---|
| K: | 2.1006E+00 | 3.9214E+01 | 7.5124E−01 | 1.3614E+00 | 7.3391E−01 | −1.4398E+00 |
| A: | −1.5056E−02 | −2.6675E−02 | −4.3750E−02 | −3.3590E−02 | 1.3140E−02 | −3.4855E−02 |
| B: | −3.9055E−04 | −4.5510E−04 | −8.1067E−03 | −8.0076E−03 | −2.5329E−03 | 9.7669E−03 |
| C: | −9.1445E−04 | −2.2176E−04 | −1.1308E−04 | 1.0560E−03 | 4.5118E−03 | −1.0726E−04 |
| D: | −4.1224E−04 | −2.6544E−04 | 3.2822E−04 | 1.1283E−04 | −2.8914E−04 | 8.6074E−05 |
| E: | 1.8353E−04 | 1.2898E−04 | 2.4045E−05 | −9.0609E−06 | −1.5438E−04 | 1.1312E−05 |
| F: | −3.1186E−05 | −2.1083E−05 | −3.1316E−06 | −3.3096E−06 | 2.8448E−05 | 1.9781E−05 |
| G: | −1.3699E−06 | 1.6792E−07 | −4.4684E−07 | 2.1661E−07 | −1.2276E−06 | −4.6485E−06 |
| surface | 8 | 9 | 10 | 11 | 12 | 13 |
| K: | −7.9608E+00 | 1.4092E+01 | −5.1555E+01 | −8.8743E+00 | −8.1662E−01 | −3.6346E+00 |
| A: | 4.4921E−03 | 3.4682E−02 | 2.2872E−02 | −1.7588E−02 | −8.4636E−02 | −3.2011E−02 |
| B: | −9.9189E−03 | −1.9360E−02 | −9.0207E−03 | 1.4342E−03 | 5.2778E−03 | 4.6356E−03 |
| C: | −9.8463E−05 | 3.8421E−04 | 1.0906E−03 | −1.2410E−03 | 6.8389E−04 | −4.2730E−04 |
| D: | 4.0088E−05 | 6.0099E−04 | −2.4014E−04 | 3.5846E−04 | −6.0417E−05 | 4.8462E−06 |
| E: | 4.9738E−06 | −8.0953E−05 | 1.1310E−06 | −8.9910E−06 | −9.1248E−07 | 4.5162E−06 |
| F: | 2.2099E−05 | −1.4877E−05 | 6.3495E−06 | −6.9895E−06 | −3.5846E−08 | −5.3319E−07 |
| G: | −3.2737E−06 | 3.1321E−06 | −5.8299E−07 | 8.8840E−07 | 1.3233E−08 | 2.0103E−08 |

In the second embodiment, the equation of the aspheric surface profiles of the aforementioned lenses is the same as the equation of the first embodiment. Also, the definitions of these parameters shown in the following table are the same as those stated in the first embodiment with corresponding values for the second embodiment, so an explanation in this regard will not be provided again.

Moreover, these parameters can be calculated from Table 3 and Table 4 as the following values and satisfy the following conditions:

Embodiment 2

| | | | |
|---|---|---|---|
| f[mm] | 4.18 | CT5*(R9/R10) [mm] | 1.51 |
| Fno | 1.20 | f/(R12*CT3) [mm⁻¹] | 7.14 |
| FOV[deg.] | 76.7 | CT6/R12 | 0.58 |
| TL/((TSI-BFL)*f) [mm⁻¹] | 0.32 | TL/f | 1.57 |
| f1/f | 1.80 | BFL/TL | 0.20 |
| f3/f4 | −1.60 | TL/IMH | 1.93 |
| f1/R1 | 2.14 | f1/f23456 | 0.96 |
| R5/R6 | 0.60 | f23/f45 | −5.21 |
| R7/R8 | 0.38 | | |

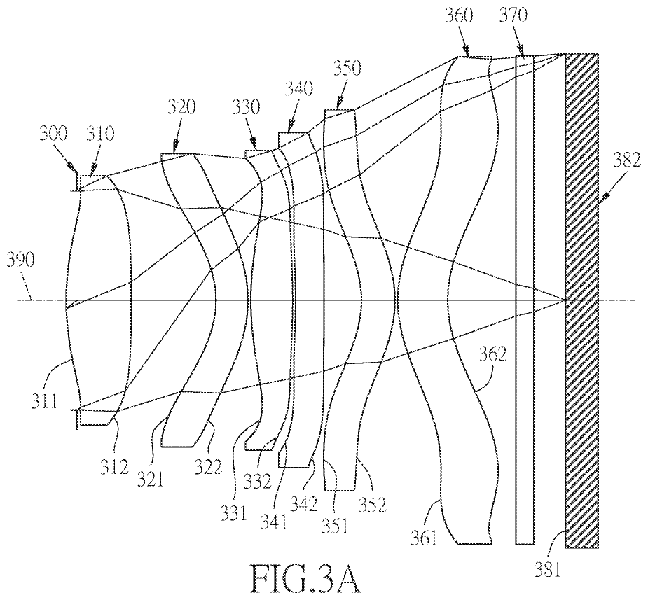

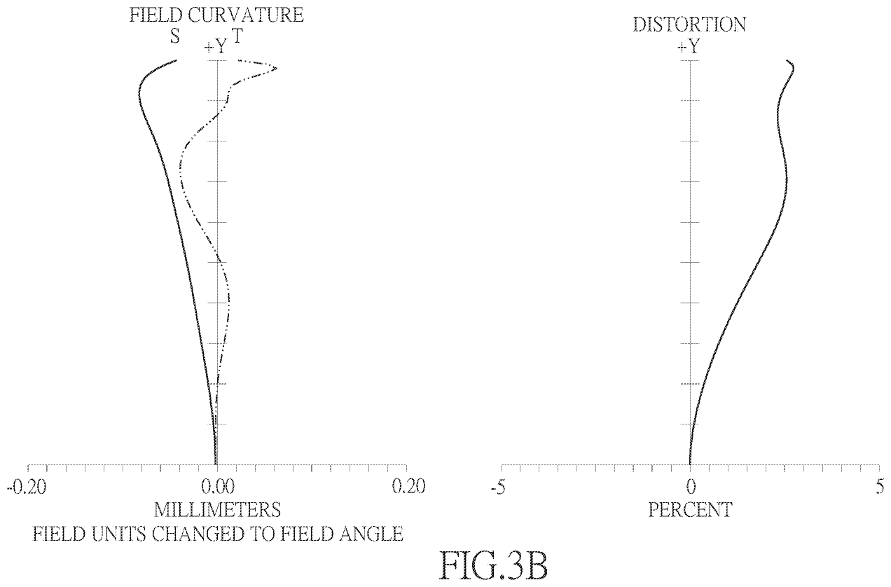

Referring to FIGS. 3A and 3B, FIG. 3A shows an optical lens system in accordance with a third embodiment of the present invention, and FIG. 3B shows, in order from left to right, the image plane curve and the distortion curve of the third embodiment of the present invention. An optical lens system in accordance with the third embodiment of the present invention comprises a stop 300 and a lens group. The optical lens system is provided with an image sensor 382. The lens group comprises, in order from an object side to an image side along an optical axis 390: a first lens 310, a second lens 320, a third lens 330, a fourth lens 340, a fifth lens 350, a sixth lens 360, an IR band-pass filter 370, and an image plane 381, wherein the optical lens system has a total of six lenses with refractive power, but not limited to this. The stop 300 is disposed between an object and the first lens 310. The image sensor 382 is disposed on the image plane 381.

The first lens 310 with positive refractive power, comprising an object-side surface 311 and an image-side surface 312, the object-side surface 311 of the first lens 310 being convex near the optical axis 390 and the image-side surface 312 of the first lens 310 being convex near the optical axis 390, the object-side surface 311 and the image-side surface 312 of the first lens 310 are aspheric, and the first lens 310 is made of plastic material.

The second lens 320 with negative refractive power, comprising an object-side surface 321 and an image-side surface 322, the object-side surface 321 of the second lens 320 being concave near the optical axis 390 and the image-side surface 322 of the second lens 320 being convex near the optical axis 390, the object-side surface 321 and the image-side surface 322 of the second lens 320 are aspheric, and the second lens 320 is made of plastic material.

The third lens 330 with positive refractive power, comprising an object-side surface 331 and an image-side surface 332, the object-side surface 331 of the third lens 330 being convex near the optical axis 390 and the image-side surface 332 of the third lens 330 being convex near the optical axis 390, the object-side surface 331 and the image-side surface 332 of the third lens 330 are aspheric, and the third lens 330 is made of plastic material.

The fourth lens 340 with negative refractive power, comprising an object-side surface 341 and an image-side surface 342, the object-side surface 341 of the fourth lens 340 being concave near the optical axis 390 and the image-side surface 342 of the fourth lens 340 being convex near the optical axis 390, the object-side surface 341 and the image-side surface 342 of the fourth lens 340 are aspheric, and the fourth lens 340 is made of plastic material.

The fifth lens 350 with negative refractive power, comprising an object-side surface 351 and an image-side surface 352, the object-side surface 351 of the fifth lens 350 being concave near the optical axis 390 and the image-side surface 352 of the fifth lens 350 being convex near the optical axis 390, the object-side surface 351 and the image-side surface 352 of the fifth lens 350 are aspheric, and the fifth lens 350 is made of plastic material.

The sixth lens 360 with positive refractive power, comprising an object-side surface 361 and an image-side surface 362, the object-side surface 361 of the sixth lens 360 being convex near the optical axis 390 and the image-side surface 362 of the sixth lens 360 being concave near the optical axis 390, the object-side surface 361 and the image-side surface 362 of the sixth lens 360 are aspheric and are provided with at least one inflection point, and the sixth lens 360 is made of plastic material.

The IR band-pass filter 370 made of glass is located between the sixth lens 360 and the image plane 381 and has no influence on the focal length of the optical lens system. The present embodiment selects a filter which is available in the light wavelength range of 940 nm±30 nm, but not limited to this.

The detailed optical data of the third embodiment is shown in table 5, and the aspheric surface data is shown in table 6.

TABLE 5
Embodiment 3
f(focal length) = 3.85 mm, Fno = 1.40, FOV = 75.7 deg.

| | | Curvature | | Thickness/ | | | Abbe | Focal |
|---|---|---|---|---|---|---|---|---|
| surface | | Radius | | gap | Material | Index(nd) | #(vd) | length |
| 0 | object | infinity | | 700.000 | | | | |
| 1 | stop | infinity | | −0.135 | | | | |
| 2 | Lens 1 | 3.372 | (ASP) | 0.776 | plastic | 1.64 | 22.5 | 5.06 |
| 3 | | −41.992 | (ASP) | 1.008 | | | | |
| 4 | Lens 2 | −1.281 | (ASP) | 0.383 | plastic | 1.64 | 22.5 | −12.47 |
| 5 | | −1.710 | (ASP) | 0.034 | | | | |
| 6 | Lens 3 | 3.947 | (ASP) | 0.497 | plastic | 1.66 | 20.4 | 4.07 |
| 7 | | −7.141 | (ASP) | 0.035 | | | | |
| 8 | Lens 4 | −6.464 | (ASP) | 0.337 | plastic | 1.64 | 22.5 | −12.02 |
| 9 | | −49.334 | (ASP) | 0.447 | | | | |
| 10 | Lens 5 | −1.403 | (ASP) | 0.402 | plastic | 1.64 | 22.5 | −95.36 |
| 11 | | −1.595 | (ASP) | 0.034 | | | | |
| 12 | Lens 6 | 1.723 | (ASP) | 0.592 | plastic | 1.64 | 22.5 | 44.91 |
| 13 | | 1.595 | (ASP) | 0.818 | | | | |

| | | | | | | |
|---|---|---|---|---|---|---|
| 14 | IR | infinity | 0.210 | glass | 1.52 | 64.2 |
| | band-pass | | | | | |
| | filter | | | | | |
| 15 | | infinity | 0.380 | | | |
| 16 | Image plane | infinity | — | | | |

Note:
reference wavelength is 940 nm

TABLE 6
Aspheric Coefficients

| surface | 2 | 3 | 4 | 5 | 6 | 7 |
|---|---|---|---|---|---|---|
| K: | −4.7869E−01 | −4.9619E+01 | −5.8392E−01 | −1.1222E+00 | 1.2562E+00 | −7.1753E+01 |
| A: | −1.4254E−02 | −2.3491E−02 | 7.8525E−02 | 2.4828E−02 | −3.3494E−02 | 4.6342E−02 |
| B: | 4.7196E−04 | −6.9391E−03 | 1.6406E−03 | 6.7002E−03 | 1.0370E−02 | −1.6409E−02 |
| C: | −7.3515E−03 | −1.3149E−03 | 2.2000E−03 | −5.5815E−05 | −3.7338E−03 | −4.9325E−03 |
| D: | 2.7825E−03 | 7.0090E−04 | 2.2536E−04 | −6.1811E−04 | −2.0509E−03 | 1.4958E−03 |
| E: | −8.6255E−04 | −1.9918E−04 | −8.1439E−05 | 1.3048E−05 | 4.9360E−04 | −6.3492E−06 |
| F: | 0.0000E+00 | 0.0000E+00 | 0.0000E+00 | 0.0000E+00 | 0.0000E+00 | 0.0000E+00 |
| G: | 0.0000E+00 | 0.0000E+00 | 0.0000E+00 | 0.0000E+00 | 0.0000E+00 | 0.0000E+00 |
| surface | 8 | 9 | 10 | 11 | 12 | 13 |
| K: | −9.7715E+01 | −7.2978E+01 | −2.0393E+00 | −1.5608E+00 | −7.3021E−01 | −8.8325E−01 |
| A: | 6.9112E−02 | 2.0814E−02 | 5.4243E−02 | 4.7352E−02 | −5.2881E−02 | −5.2611E−02 |
| B: | −3.2329E−02 | −1.7013E−02 | −1.7392E−03 | 3.6419E−04 | −7.8613E−04 | 6.0350E−05 |
| C: | −4.5710E−03 | 4.7181E−03 | −7.0691E−04 | −4.5470E−04 | 6.1671E−04 | 1.1366E−03 |
| D: | 5.8572E−03 | −2.6911E−04 | −4.8525E−05 | −9.7587E−05 | −4.9056E−05 | −2.5623E−04 |
| E: | −1.3296E−03 | −2.1095E−04 | 8.4691E−06 | 2.3271E−06 | 2.7961E−06 | 2.5498E−05 |
| F: | 8.5543E−05 | 3.4657E−05 | 1.4334E−06 | 1.6801E−06 | −1.4351E−07 | −9.2755E−07 |
| G: | 0.0000E+00 | 0.0000E+00 | 0.0000E+00 | 0.0000E+00 | −1.5196E−09 | 2.4046E−09 |

In the third embodiment, the equation of the aspheric surface profiles of the aforementioned lenses is the same as the equation of the first embodiment. Also, the definitions of these parameters shown in the following table are the same as those stated in the first embodiment with corresponding values for the third embodiment, so an explanation in this regard will not be provided again.

Moreover, these parameters can be calculated from Table 5 and Table 6 as the following values and satisfy the following conditions:

Embodiment 3

| | | | |
|---|---|---|---|
| f[mm] | 3.85 | CT5*(R9/R10) [mm] | 0.35 |
| Fno | 1.40 | f/(R12*CT3) [mm⁻¹] | 4.86 |
| FOV[deg.] | 75.7 | CT6/R12 | 0.37 |
| TL/((TSI-BFL)*f) [mm⁻¹] | 0.35 | TL/f | 1.55 |
| f1/f | 1.31 | BFL/TL | 0.24 |
| f3/f4 | −0.34 | TL/IMH | 1.93 |
| f1/R1 | 1.50 | f1/f23456 | 0.62 |
| R5/R6 | −0.55 | f23/f45 | −0.44 |
| R7/R8 | 0.13 | | |

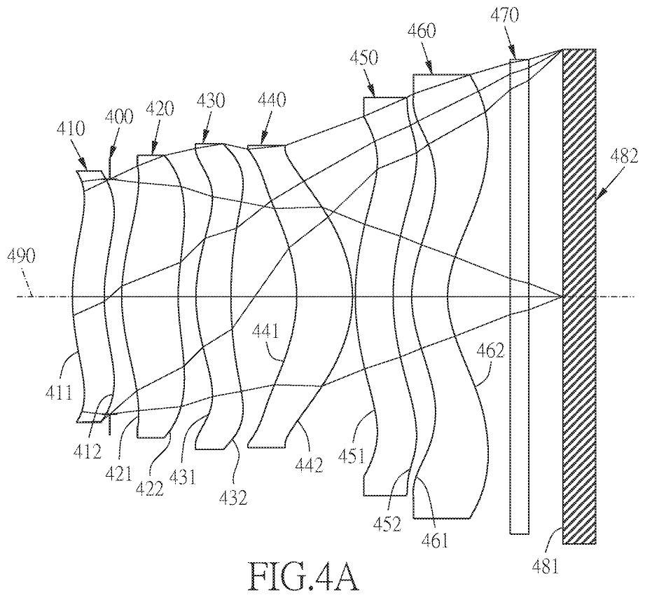

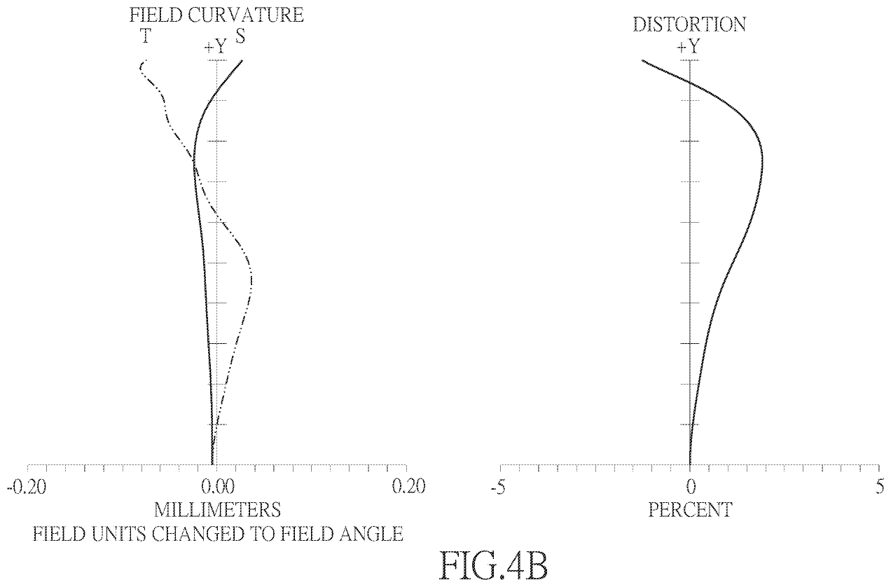

Referring to FIGS. 4A and 4B, FIG. 4A shows an optical lens system in accordance with a fourth embodiment of the present invention, and FIG. 4B shows, in order from left to right, the image plane curve and the distortion curve of the fourth embodiment of the present invention. An optical lens system in accordance with the fourth embodiment of the present invention comprises a stop 400 and a lens group. The optical lens system is provided with an image sensor 482. The lens group comprises, in order from an object side to an image side along an optical axis 490: a first lens 410, a second lens 420, a third lens 430, a fourth lens 440, a fifth lens 450, a sixth lens 460, an IR band-pass filter 470, and an image plane 481, wherein the optical lens system has a total of six lenses with refractive power, but not limited to this. The stop 400 is disposed between the first lens 410 and the second lens 420. The image sensor 482 is disposed on the image plane 481.

The first lens 410 with negative refractive power, comprising an object-side surface 411 and an image-side surface 412, the object-side surface 411 of the first lens 410 being convex near the optical axis 490 and the image-side surface 412 of the first lens 410 being concave near the optical axis 490, the object-side surface 411 and the image-side surface 412 of the first lens 410 are aspheric, and the first lens 410 is made of plastic material.

The second lens 420 with positive refractive power, comprising an object-side surface 421 and an image-side surface 422, the object-side surface 421 of the second lens 420 being convex near the optical axis 490 and the image-side surface 422 of the second lens 420 being concave near the optical axis 490, the object-side surface 421 and the image-side surface 422 of the second lens 420 are aspheric, and the second lens 420 is made of plastic material.

The third lens 430 with positive refractive power, comprising an object-side surface 431 and an image-side surface 432, the object-side surface 431 of the third lens 430 being convex near the optical axis 490 and the image-side surface 432 of the third lens 430 being concave near the optical axis 490, the object-side surface 431 and the image-side surface 432 of the third lens 430 are aspheric, and the third lens 430 is made of plastic material.

The fourth lens 440 with positive refractive power, comprising an object-side surface 441 and an image-side surface 442, the object-side surface 441 of the fourth lens 440 being concave near the optical axis 490 and the image-side surface 442 of the fourth lens 440 being convex near the optical axis 490, the object-side surface 441 and the image-side surface 442 of the fourth lens 440 are aspheric, and the fourth lens 440 is made of plastic material.

The fifth lens 450 with negative refractive power, comprising an object-side surface 451 and an image-side surface 452, the object-side surface 451 of the fifth lens 450 being convex near the optical axis 490 and the image-side surface 452 of the fifth lens 450 being concave near the optical axis 490, the object-side surface 451 and the image-side surface 452 of the fifth lens 450 are aspheric, and the fifth lens 450 is made of plastic material.

The sixth lens 460 with negative refractive power, comprising an object-side surface 461 and an image-side surface 462, the object-side surface 461 of the sixth lens 460 being convex near the optical axis 490 and the image-side surface 462 of the sixth lens 460 being concave near the optical axis 490, the object-side surface 461 and the image-side surface 462 of the sixth lens 460 are aspheric and are provided with at least one inflection point, and the sixth lens 460 is made of plastic material.

The IR band-pass filter 470 made of glass is located between the sixth lens 460 and the image plane 481 and has no influence on the focal length of the optical lens system. The present embodiment selects a filter which is available in the light wavelength range of 940 nm±30 nm, but not limited to this.

The detailed optical data of the fourth embodiment is shown in table 7, and the aspheric surface data is shown in table 8.

TABLE 7
Embodiment 4
f(focal length) = 3.52 mm, Fno = 1.30, FOV = 79.3 deg.

| | | Curvature | | Thickness/ | | | Abbe | Focal |
|---|---|---|---|---|---|---|---|---|
| surface | | Radius | | gap | Material | Index(nd) | #(vd) | length |
| 0 | object | infinity | | 450.000 | | | | |
| 1 | Lens 1 | 2.725 | (ASP) | 0.358 | plastic | 1.64 | 22.5 | −23.92 |
| 2 | | 2.187 | (ASP) | 0.062 | | | | |
| 3 | stop | infinity | | 0.135 | | | | |
| 4 | Lens 2 | 2.213 | (ASP) | 0.633 | plastic | 1.64 | 22.5 | 12.92 |
| 5 | | 2.721 | (ASP) | 0.198 | | | | |
| 6 | Lens 3 | 1.958 | (ASP) | 0.393 | plastic | 1.64 | 22.5 | 4.41 |
| 7 | | 6.349 | (ASP) | 0.738 | | | | |
| 8 | Lens 4 | −1.876 | (ASP) | 0.626 | plastic | 1.64 | 22.5 | 8.51 |
| 9 | | −1.561 | (ASP) | 0.034 | | | | |
| 10 | Lens 5 | 3.383 | (ASP) | 0.422 | plastic | 1.64 | 22.5 | −118.41 |
| 11 | | 3.079 | (ASP) | 0.211 | | | | |
| 12 | Lens 6 | 1.482 | (ASP) | 0.400 | plastic | 1.64 | 22.5 | −19.21 |
| 13 | | 1.182 | (ASP) | 0.704 | | | | |

| | | | | | | |
|---|---|---|---|---|---|---|
| 14 | IR | infinity | 0.210 | glass | 1.52 | 64.2 |
| | band-pass | | | | | |
| | filter | | | | | |
| 15 | | infinity | 0.380 | | | |
| 16 | Image plane | infinity | — | | | |

Note:
reference wavelength is 940 nm

TABLE 8
Aspheric Coefficients

| surface | 1 | 2 | 4 | 5 | 6 | 7 |
|---|---|---|---|---|---|---|
| K: | −9.3789E+00 | −1.2964E+01 | −5.1907E+00 | −1.2197E+01 | −1.3045E+01 | −1.7897E+01 |
| A: | −6.3843E−03 | −2.4955E−02 | −7.8229E−02 | −1.1969E−01 | 9.0876E−02 | 5.5952E−02 |
| B: | −1.2651E−02 | 1.4301E−02 | 1.0994E−01 | 9.4180E−02 | −1.6752E−01 | −4.1392E−02 |
| C: | 3.3942E−03 | −7.4521E−02 | −1.0669E−01 | −6.8968E−02 | 1.4764E−01 | 1.4253E−02 |
| D: | −1.5572E−02 | 4.7863E−02 | 3.0682E−02 | 2.1008E−02 | −9.7386E−02 | −4.0771E−03 |
| E: | 1.0961E−02 | −9.0276E−03 | 1.2341E−02 | 3.1332E−03 | 3.5249E−02 | −4.8015E−04 |
| F: | −3.0242E−03 | −1.1594E−03 | −8.7346E−03 | −3.4636E−03 | −6.0160E−03 | 3.3301E−04 |
| G: | 2.8186E−04 | 4.2225E−04 | 1.3187E−03 | 5.7617E−04 | 3.8136E−04 | −2.3044E−05 |
| surface | 8 | 9 | 10 | 11 | 12 | 13 |
| K: | −8.5037E+00 | −8.4970E−01 | −1.4057E+00 | −5.6624E−01 | −4.3008E+00 | −2.6379E+00 |
| A: | −1.1624E−01 | 9.0147E−03 | 1.8899E−02 | 1.0020E−02 | −1.9545E−02 | −6.4733E−02 |
| B: | 1.4949E−01 | 1.5947E−02 | −3.4780E−02 | −3.4379E−02 | −3.6515E−02 | 9.4625E−03 |
| C: | −1.5487E−01 | −2.2990E−02 | 1.6207E−02 | 1.5804E−02 | 1.8176E−02 | 5.8872E−04 |
| D: | 1.1797E−01 | 1.5779E−02 | −4.3962E−03 | −4.0149E−03 | −3.8465E−03 | −6.4513E−04 |
| E: | −4.9823E−02 | −4.2645E−03 | 3.0966E−04 | 2.9909E−04 | 2.2636E−04 | 1.5576E−04 |
| F: | 1.0153E−02 | 2.4423E−04 | 8.0163E−05 | 5.2407E−05 | 4.1618E−05 | −1.8786E−05 |
| G: | −7.7943E−04 | 5.2161E−05 | −1.1092E−05 | −7.0548E−06 | −4.9064E−06 | 9.1408E−07 |

In the fourth embodiment, the equation of the aspheric surface profiles of the aforementioned lenses is the same as the equation of the first embodiment. Also, the definitions of these parameters shown in the following table are the same as those stated in the first embodiment with corresponding values for the fourth embodiment, so an explanation in this regard will not be provided again.

Moreover, these parameters can be calculated from Table 7 and Table 8 as the following values and satisfy the following conditions:

Embodiment 4

| | | | |
|---|---|---|---|
| f[mm] | 3.52 | CT5*(R9/R10) [mm] | 0.46 |
| Fno | 1.30 | f/(R12*CT3) [mm⁻¹] | 7.56 |
| FOV[deg.] | 79.3 | CT6/R12 | 0.34 |
| TL/((TSI-BFL)*f) [mm⁻¹] | 0.41 | TL/f | 1.57 |
| f1/f | −6.80 | BFL/TL | 0.24 |
| f3/f4 | 0.52 | TL/IMH | 1.90 |
| f1/R1 | −8.78 | f1/f23456 | −8.05 |
| R5/R6 | 0.31 | f23/f45 | 0.41 |
| R7/R8 | 1.20 | | |

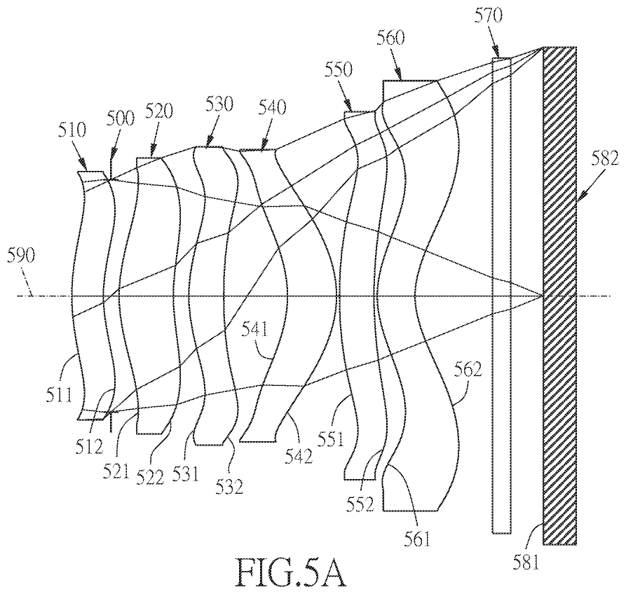

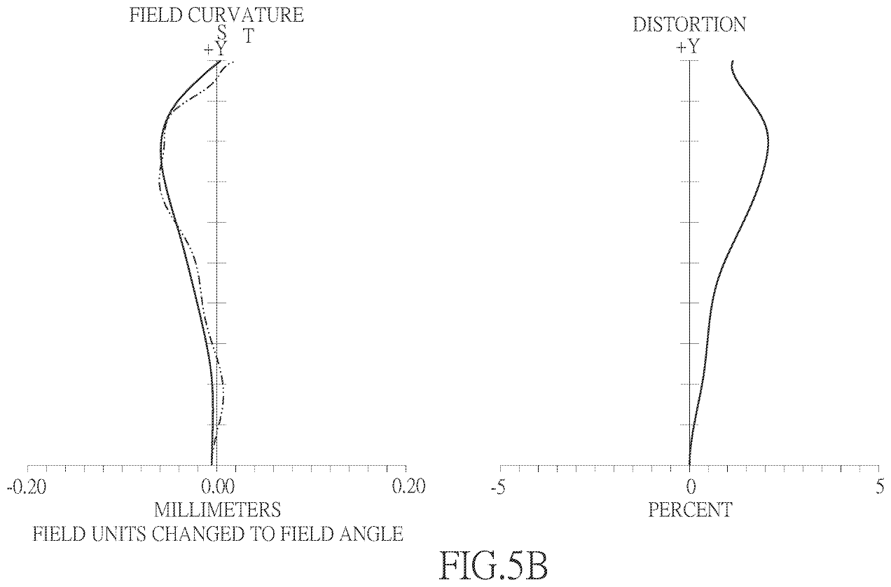

Referring to FIGS. 5A and 5B, FIG. 5A shows an optical lens system in accordance with a fifth embodiment of the present invention, and FIG. 5B shows, in order from left to right, the image plane curve and the distortion curve of the fifth embodiment of the present invention. An optical lens system in accordance with the fifth embodiment of the present invention comprises a stop 500 and a lens group. The optical lens system is provided with an image sensor 582. The lens group comprises, in order from an object side to an image side along an optical axis 590: a first lens 510, a second lens 520, a third lens 530, a fourth lens 540, a fifth lens 550, a sixth lens 560, an IR band-pass filter 570, and an image plane 581, wherein the optical lens system has a total of six lenses with refractive power, but not limited to this. The stop 500 is disposed between the first lens 510 and the second lens 520. The image sensor 582 is disposed on the image plane 581.

The first lens 510 with negative refractive power, comprising an object-side surface 511 and an image-side surface 512, the object-side surface 511 of the first lens 510 being convex near the optical axis 590 and the image-side surface 512 of the first lens 510 being concave near the optical axis 590, the object-side surface 511 and the image-side surface 512 of the first lens 510 are aspheric, and the first lens 510 is made of plastic material.

The second lens 520 with positive refractive power, comprising an object-side surface 521 and an image-side surface 522, the object-side surface 521 of the second lens 520 being convex near the optical axis 590 and the image-side surface 522 of the second lens 520 being concave near the optical axis 590, the object-side surface 521 and the image-side surface 522 of the second lens 520 are aspheric, and the second lens 520 is made of plastic material.

The third lens 530 with positive refractive power, comprising an object-side surface 531 and an image-side surface 532, the object-side surface 531 of the third lens 530 being convex near the optical axis 590 and the image-side surface 532 of the third lens 530 being concave near the optical axis 590, the object-side surface 531 and the image-side surface 532 of the third lens 530 are aspheric, and the third lens 530 is made of plastic material.

The fourth lens 540 with positive refractive power, comprising an object-side surface 541 and an image-side surface 542, the object-side surface 541 of the fourth lens 540 being concave near the optical axis 590 and the image-side surface 542 of the fourth lens 540 being convex near the optical axis 590, the object-side surface 541 and the image-side surface 542 of the fourth lens 540 are aspheric, and the fourth lens 540 is made of plastic material.

The fifth lens 550 with positive refractive power, comprising an object-side surface 551 and an image-side surface 552, the object-side surface 551 of the fifth lens 550 being convex near the optical axis 590 and the image-side surface 552 of the fifth lens 550 being concave near the optical axis 590, the object-side surface 551 and the image-side surface 552 of the fifth lens 550 are aspheric, and the fifth lens 550 is made of plastic material.

The sixth lens 560 with negative refractive power, comprising an object-side surface 561 and an image-side surface 562, the object-side surface 561 of the sixth lens 560 being convex near the optical axis 590 and the image-side surface 562 of the sixth lens 560 being concave near the optical axis 590, the object-side surface 561 and the image-side surface 562 of the sixth lens 560 are aspheric and are provided with at least one inflection point, and the sixth lens 560 is made of plastic material.

The IR band-pass filter 570 made of glass is located between the sixth lens 560 and the image plane 581 and has no influence on the focal length of the optical lens system. The present embodiment selects a filter which is available in the light wavelength range of 940 nm±30 nm, but not limited to this.

The detailed optical data of the fifth embodiment is shown in table 9, and the aspheric surface data is shown in table 10.

TABLE 9
Embodiment 5
f(focal length) = 3.47 mm, Fno = 1.26, FOV = 80.6 deg.

| | | Curvature | | Thickness/ | | | Abbe | Focal |
|---|---|---|---|---|---|---|---|---|
| surface | | Radius | | gap | Material | Index(nd) | #(vd) | length |
| 0 | object | infinity | | 450.000 | | | | |
| 1 | Lens 1 | 2.576 | (ASP) | 0.365 | plastic | 1.64 | 22.5 | −12.98 |
| 2 | | 1.846 | (ASP) | 0.088 | | | | |
| 3 | stop | infinity | | 0.092 | | | | |
| 4 | Lens 2 | 1.853 | (ASP) | 0.627 | plastic | 1.64 | 22.5 | 8.54 |
| 5 | | 2.479 | (ASP) | 0.178 | | | | |
| 6 | Lens 3 | 1.993 | (ASP) | 0.403 | plastic | 1.64 | 22.5 | 4.34 |
| 7 | | 7.043 | (ASP) | 0.735 | | | | |
| 8 | Lens 4 | −1.489 | (ASP) | 0.563 | plastic | 1.64 | 22.5 | 12.34 |
| 9 | | −1.427 | (ASP) | 0.035 | | | | |
| 10 | Lens 5 | 5.969 | (ASP) | 0.400 | plastic | 1.64 | 22.5 | 92.00 |
| 11 | | 6.494 | (ASP) | 0.035 | | | | |
| 12 | Lens 6 | 1.255 | (ASP) | 0.436 | plastic | 1.64 | 22.5 | −78.01 |
| 13 | | 1.061 | (ASP) | 0.893 | | | | |

| | | | | | | |
|---|---|---|---|---|---|---|
| 14 | IR | infinity | 0.210 | glass | 1.52 | 64.2 |
| | band-pass | | | | | |
| | filter | | | | | |
| 15 | | infinity | 0.380 | | | |
| 16 | Image plane | infinity | — | | | |

Note:
reference wavelength is 940 nm

TABLE 10
Aspheric Coefficients

| surface | 1 | 2 | 4 | 5 | 6 | 7 |
|---|---|---|---|---|---|---|
| K: | −1.2853E+01 | −1.2702E+01 | −6.3015E+00 | −7.8369E+00 | −1.1902E+01 | 1.3873E+01 |
| A: | 3.4430E−03 | −1.7119E−02 | −6.6460E−02 | −1.3797E−01 | 8.4696E−02 | 5.6687E−02 |
| B: | −7.6851E−03 | 1.4905E−02 | 1.0886E−01 | 9.6668E−02 | −1.6687E−01 | −3.8576E−02 |
| C: | −1.3794E−03 | −7.6319E−02 | −1.0891E−01 | −6.6071E−02 | 1.4961E−01 | 1.2587E−02 |
| D: | −1.4173E−02 | 4.8044E−02 | 3.0255E−02 | 2.0708E−02 | −9.7351E−02 | −4.4561E−03 |
| E: | 1.1412E−02 | −8.8817E−03 | 1.2688E−02 | 2.8549E−03 | 3.5119E−02 | −4.1460E−04 |
| F: | −3.3908E−03 | −1.1385E−03 | −8.5782E−03 | −3.4977E−03 | −6.0349E−03 | 3.4131E−04 |
| G: | 3.4113E−04 | 4.0484E−04 | 1.2583E−03 | 6.0453E−04 | 3.9026E−04 | −2.3616E−05 |
| surface | 8 | 9 | 10 | 11 | 12 | 13 |
| K: | −6.9257E+00 | −1.1747E+00 | 6.2468E+00 | 4.5838E+00 | −3.7697E+00 | −2.8746E+00 |
| A: | −1.0895E−01 | 2.0574E−02 | 3.4915E−02 | 1.6049E−02 | −2.3047E−02 | −5.0395E−02 |
| B: | 1.5645E−01 | 1.0278E−02 | −3.3877E−02 | −2.5998E−02 | −3.2271E−02 | 4.4379E−03 |
| C: | −1.5365E−01 | −2.0169E−02 | 1.4767E−02 | 1.3981E−02 | 1.6831E−02 | 1.2881E−03 |
| D: | 1.1685E−01 | 1.5562E−02 | −4.0619E−03 | −4.1553E−03 | −3.9247E−03 | −6.8252E−04 |
| E: | −5.0121E−02 | −4.5214E−03 | 3.2132E−04 | 3.1317E−04 | 2.5948E−04 | 1.4756E−04 |
| F: | 1.0160E−02 | 2.2955E−04 | 3.6218E−05 | 5.8650E−05 | 4.6622E−05 | −1.6775E−05 |
| G: | −7.4944E−04 | 7.1241E−05 | −4.3325E−06 | −7.2822E−06 | −5.7571E−06 | 7.9132E−07 |

In the fifth embodiment, the equation of the aspheric surface profiles of the aforementioned lenses is the same as the equation of the first embodiment. Also, the definitions of these parameters shown in the following table are the same as those stated in the first embodiment with corresponding values for the fifth embodiment, so an explanation in this regard will not be provided again.

Moreover, these parameters can be calculated from Table 9 and Table 10 as the following values and satisfy the following conditions:

Embodiment 5

| | | | |
|---|---|---|---|
| f[mm] | 3.47 | CT5*(R9/R10) [mm] | 0.37 |
| Fno | 1.26 | f/(R12*CT3) [mm⁻¹] | 8.11 |
| FOV[deg.] | 80.6 | CT6/R12 | 0.41 |
| TL/((TSI-BFL)*f) [mm⁻¹] | 0.45 | TL/f | 1.57 |
| f1/f | −3.74 | BFL/TL | 0.27 |
| f3/f4 | 0.35 | TL/IMH | 1.81 |
| f1/R1 | −5.04 | f1/f23456 | −4.78 |
| R5/R6 | 0.28 | f23/f45 | 0.30 |
| R7/R8 | 1.04 | | |

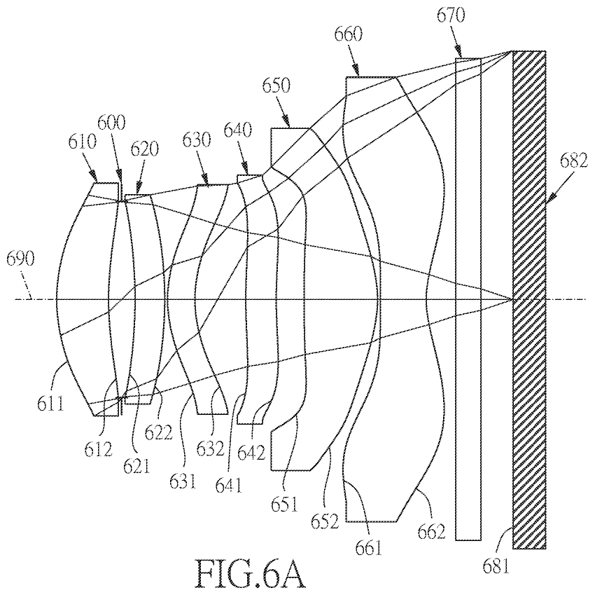

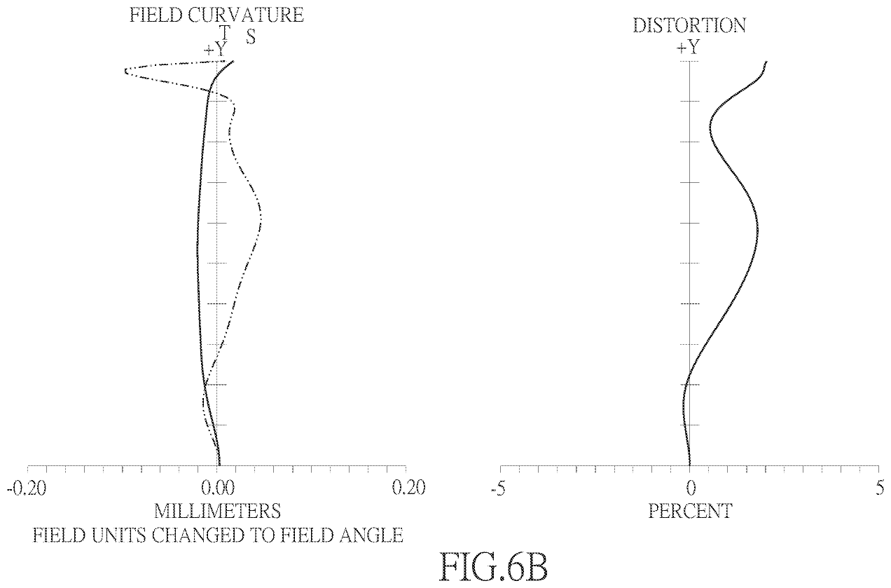

Referring to FIGS. 6A and 6B, FIG. 6A shows an optical lens system in accordance with a sixth embodiment of the present invention, and FIG. 6B shows, in order from left to right, the image plane curve and the distortion curve of the sixth embodiment of the present invention. An optical lens system in accordance with the sixth embodiment of the present invention comprises a stop 600 and a lens group.

The optical lens system is provided with an image sensor 682. The lens group comprises, in order from an object side to an image side along an optical axis 690: a first lens 610, a second lens 620, a third lens 630, a fourth lens 640, a fifth lens 650, a sixth lens 660, an IR band-pass filter 670, and an image plane 681, wherein the optical lens system has a total of six lenses with refractive power, but not limited to this. The stop 600 is disposed between the first lens 610 and the second lens 620. The image sensor 682 is disposed on the image plane 681.

The first lens 610 with negative refractive power, comprising an object-side surface 611 and an image-side surface 612, the object-side surface 611 of the first lens 610 being convex near the optical axis 690 and the image-side surface 612 of the first lens 610 being concave near the optical axis 690, the object-side surface 611 and the image-side surface 612 of the first lens 610 are aspheric, and the first lens 610 is made of plastic material.

The second lens 620 with positive refractive power, comprising an object-side surface 621 and an image-side surface 622, the object-side surface 621 of the second lens 620 being convex near the optical axis 690 and the image-side surface 622 of the second lens 620 being concave near the optical axis 690, the object-side surface 621 and the image-side surface 622 of the second lens 620 are aspheric, and the second lens 620 is made of plastic material.

The third lens 630 with positive refractive power, comprising an object-side surface 631 and an image-side surface 632, the object-side surface 631 of the third lens 630 being convex near the optical axis 690 and the image-side surface 632 of the third lens 630 being concave near the optical axis 690, the object-side surface 631 and the image-side surface 632 of the third lens 630 are aspheric, and the third lens 630 is made of plastic material.

The fourth lens 640 with positive refractive power, comprising an object-side surface 641 and an image-side surface 642, the object-side surface 641 of the fourth lens 640 being concave near the optical axis 690 and the image-side surface 642 of the fourth lens 640 being convex near the optical axis 690, the object-side surface 641 and the image-side surface 642 of the fourth lens 640 are aspheric, and the fourth lens 640 is made of plastic material.

The fifth lens 650 with positive refractive power, comprising an object-side surface 651 and an image-side surface 652, the object-side surface 651 of the fifth lens 650 being convex near the optical axis 690 and the image-side surface 652 of the fifth lens 650 being concave near the optical axis 690, the object-side surface 651 and the image-side surface 652 of the fifth lens 650 are aspheric, and the fifth lens 650 is made of plastic material.

The sixth lens 660 with negative refractive power, comprising an object-side surface 661 and an image-side surface 662, the object-side surface 661 of the sixth lens 660 being convex near the optical axis 690 and the image-side surface 662 of the sixth lens 660 being concave near the optical axis 690, the object-side surface 661 and the image-side surface 662 of the sixth lens 660 are aspheric and are provided with at least one inflection point, and the sixth lens 660 is made of plastic material.

The IR band-pass filter 670 made of glass is located between the sixth lens 660 and the image plane 681 and has no influence on the focal length of the optical lens system. The present embodiment selects a filter which is available in the light wavelength range of 940 nm±30 nm, but not limited to this.

The detailed optical data of the sixth embodiment is shown in table 11, and the aspheric surface data is shown in table 12.

TABLE 11
Embodiment 6
f(focal length) = 3.90 mm, Fno = 1.50, FOV = 75.0 deg.

| | | Curvature | | Thickness/ | | | Abbe | Focal |
|---|---|---|---|---|---|---|---|---|
| surface | | Radius | | gap | Material | Index(nd) | #(vd) | length |
| 0 | object | infinity | | 600.000 | | | | |
| 1 | Lens 1 | 2.207 | (ASP) | 0.614 | plastic | 1.64 | 22.5 | 6.66 |
| 2 | | 4.230 | (ASP) | 0.155 | | | | |
| 3 | stop | infinity | | 0.159 | | | | |
| 4 | Lens 2 | −6.606 | (ASP) | 0.351 | plastic | 1.64 | 22.5 | 38.73 |
| 5 | | −5.288 | (ASP) | 0.035 | | | | |
| 6 | Lens 3 | 1.720 | (ASP) | 0.324 | plastic | 1.64 | 22.5 | 31.84 |
| 7 | | 1.748 | (ASP) | 0.604 | | | | |
| 8 | Lens 4 | 6.993 | (ASP) | 0.362 | plastic | 1.64 | 22.5 | −99.48 |
| 9 | | 6.157 | (ASP) | 0.327 | | | | |
| 10 | Lens 5 | 23.808 | (ASP) | 0.872 | plastic | 1.64 | 22.5 | 2.40 |
| 11 | | −1.566 | (ASP) | 0.035 | | | | |
| 12 | Lens 6 | 111.155 | (ASP) | 0.542 | plastic | 1.64 | 22.5 | −2.17 |
| 13 | | 1.329 | (ASP) | 0.347 | | | | |

| | | | | | | |
|---|---|---|---|---|---|---|
| 14 | IR | infinity | 0.300 | glass | 1.52 | 64.2 |
| | band-pass | | | | | |
| | filter | | | | | |
| 15 | | infinity | 0.380 | | | |
| 16 | Image plane | infinity | — | | | |

Note:
reference wavelength is 940 nm

TABLE 12
Aspheric Coefficients

| surface | 1 | 2 | 4 | 5 | 6 | 7 |
|---|---|---|---|---|---|---|
| K: | −3.8429E−01 | 2.2752E+00 | −1.8535E−01 | 4.1528E−02 | −2.1421E+00 | −2.9705E+00 |
| A: | −6.2214E−03 | −3.3244E−02 | 4.0717E−04 | −6.6057E−04 | −4.3097E−03 | 4.0339E−02 |
| B: | 2.0090E−03 | −3.0805E−04 | −1.7436E−03 | −1.9312E−03 | 1.9003E−02 | −3.0123E−02 |
| C: | −6.1471E−03 | 1.0485E−02 | −3.5138E−05 | −6.3536E−05 | −8.2320E−02 | 8.1254E−03 |
| D: | 6.9738E−03 | −1.7496E−02 | −2.2480E−05 | 8.4748E−06 | 9.0992E−02 | −2.3715E−02 |
| E: | −5.0363E−03 | 1.1737E−02 | −2.8819E−06 | −4.2666E−06 | −5.7319E−02 | 2.4475E−02 |
| F: | 1.6561E−03 | −4.1469E−03 | 0.0000E+00 | 0.0000E+00 | 1.8692E−02 | −1.0755E−02 |
| G: | −2.4469E−04 | 5.8913E−04 | 0.0000E+00 | 0.0000E+00 | −2.3200E−03 | 1.7800E−03 |
| surface | 8 | 9 | 10 | 11 | 12 | 13 |
| K: | −9.4235E+01 | −5.4166E+01 | 1.9108E+01 | −3.4339E+00 | 7.3374E+01 | −8.1311E+00 |
| A: | −2.3854E−02 | −4.7991E−02 | 3.2432E−02 | 1.3925E−01 | −1.0791E−01 | −6.9147E−02 |
| B: | −4.4770E−02 | 3.6800E−03 | −4.9142E−02 | −1.7467E−01 | 6.5438E−03 | 2.4311E−02 |
| C: | 7.2849E−02 | −2.1881E−02 | 5.4009E−02 | 1.3846E−01 | 1.4311E−02 | −7.2136E−03 |
| D: | −6.0627E−02 | 2.0060E−02 | −5.9171E−02 | −6.3408E−02 | −4.8286E−03 | 1.1766E−03 |
| E: | 2.3609E−02 | −1.0617E−02 | 3.7053E−02 | 1.5518E−02 | 6.8825E−04 | −9.1354E−05 |
| F: | −3.5793E−03 | 2.3920E−03 | −1.3303E−02 | −1.8719E−03 | −4.7120E−05 | 2.8514E−06 |
| G: | 0.0000E+00 | 0.0000E+00 | 1.9344E−03 | 8.6051E−05 | 1.2565E−06 | −2.1559E−08 |

In the sixth embodiment, the equation of the aspheric surface profiles of the aforementioned lenses is the same as the equation of the first embodiment. Also, the definitions of these parameters shown in the following table are the same as those stated in the first embodiment with corresponding values for the sixth embodiment, so an explanation in this regard will not be provided again.

Moreover, these parameters can be calculated from Table 11 and Table 12 as the following values and satisfy the following conditions:

Embodiment 6

| | | | |
|---|---|---|---|
| f[mm] | 3.90 | CT5*(R9/R10) [mm] | −13.25 |
| Fno | 1.50 | f/(R12*CT3) [mm⁻¹] | 9.08 |
| FOV[deg.] | 75.0 | CT6/R12 | 0.41 |
| TL/((TSI-BFL)*f) [mm⁻¹] | 0.38 | TL/f | 1.38 |
| f1/f | 1.71 | BFL/TL | 0.19 |
| f3/f4 | −0.32 | TL/IMH | 1.75 |
| f1/R1 | 3.02 | f1/f23456 | 0.60 |
| R5/R6 | 0.98 | f23/f45 | 6.74 |
| R7/R8 | 1.14 | | |

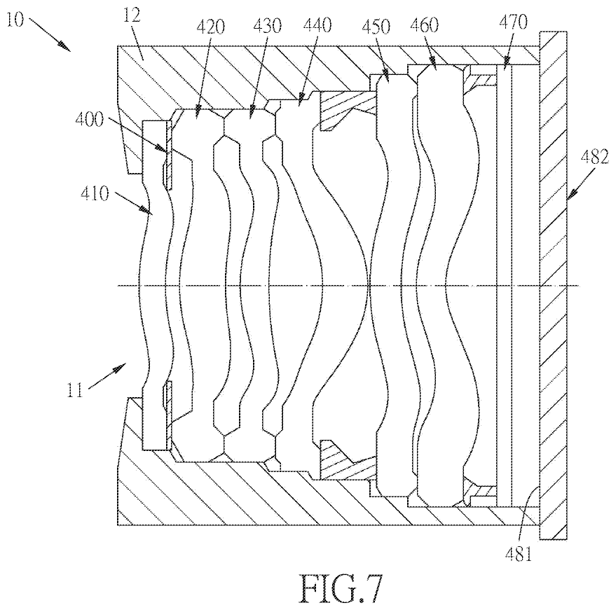

Referring to FIG. 7, which shows a photographing module in accordance with a seventh embodiment of the present invention, the photographing module is applied to a notebook, but not limited to this. The photographing module 10 includes an optical lens system 11, a lens barrel 12 and an image sensor 482. The optical lens system 11 is the optical lens system of the above fourth embodiment, but not limited to this, and can also be the optical lens systems of other embodiments. In addition, the lenses of the optical lens system in FIG. 7 show the unlit peripheral parts, which is slightly different from that of the fourth embodiment. The lens barrel 12 is provided for accommodating the optical lens system 11. The image sensor 482 is disposed on an image plane 481 of the optical lens system and is an electronic sensor (such as, CMOS, CCD) with good brightness and low noise to really present the imaging quality of the optical lens system.

In the present optical lens system, the lenses can be made of plastic or glass. If the lenses are made of plastic, the cost will be effectively reduced. If the lenses are made of glass, there is more freedom in distributing the refractive power of the optical lens system. Plastic lenses can have aspheric surfaces, which allow more design parameter freedom (than spherical surfaces), so as to reduce the aberration and the number of the lenses, as well as the total length of the optical lens system.

In the present optical lens system, if the object-side or the image-side surface of the lenses with refractive power is convex and the location of the convex surface is not defined, the object-side or the image-side surface of the lenses near the optical axis is convex. If the object-side or the image-side surface of the lenses is concave and the location of the concave surface is not defined, the object-side or the image-side surface of the lenses near the optical axis is concave.

The optical lens system of the present invention can be used in focusing optical systems and can obtain better image quality. The optical lens system of the present invention can also be used in electronic imaging systems, such as, 3D image capturing, digital camera, mobile device, digital flat panel or vehicle camera.

While we have shown and described various embodiments in accordance with the present invention, it should be clear to those skilled in the art that further embodiments may be made without departing from the scope of the present invention.

What is claimed is:

1. An optical lens system, in order from an object side to an image side, comprising:
a first lens with refractive power, comprising an object-side surface and an image-side surface, the object-side surface of the first lens being convex near an optical axis, and at least one of the object-side surface and the image-side surface of the first lens being aspheric;
a second lens with refractive power, comprising an object-side surface and an image-side surface, and at least one of the object-side surface and the image-side surface of the second lens being aspheric;
a third lens with refractive power, comprising an object-side surface and an image-side surface, and at least one of the object-side surface and the image-side surface of the third lens being aspheric;
a fourth lens with refractive power, comprising an object-side surface and an image-side surface, and at least one of the object-side surface and the image-side surface of the fourth lens being aspheric;
a fifth lens with refractive power, comprising an object-side surface and an image-side surface, and at least one of the object-side surface and the image-side surface of the fifth lens being aspheric;
a sixth lens with refractive power, comprising an object-side surface and an image-side surface, the object-side surface of the sixth lens being convex near the optical axis and the image-side surface of the sixth lens being concave near the optical axis, and at least one of the object-side surface and the image-side surface of the sixth lens being aspheric and provided with an inflection point; and
an IR band-pass filter;
wherein a stop is disposed before the object-side surface of the first lens or between the image-side surface of the first lens and the object-side surface of the second lens, a distance from the stop to an image plane along the optical axis is TSI, a distance from the object-side surface of the first lens to the image plane along the optical axis is TL, a distance from the image-side surface of the sixth lens to the image plane along the optical axis is BFL, a focal length of the optical lens system is f, and following condition is satisfied: 0.25 mm⁻¹<TL/((TSI−BFL)*f)<0.49 mm⁻¹.

2. The optical lens system as claimed in claim 1, wherein a focal length of the third lens is f3, a focal length of the fourth lens is f4, and following condition is satisfied: −1.93<f3/f4<0.62.

3. The optical lens system as claimed in claim 1, wherein a focal length of the first lens is f1, a radius of curvature of the object-side surface of the first lens is R1, and following condition is satisfied: −10.53<f1/R1<3.62.

4. The optical lens system as claimed in claim 1, wherein a focal length of the first lens is f1, the focal length of the optical lens system is f, and following condition is satisfied: −8.16<f1/f<2.15.

5. The optical lens system as claimed in claim 1, wherein a radius of curvature of the object-side surface of the third lens is R5, a radius of curvature of the image-side surface of the third lens is R6, and following condition is satisfied: −0.66<R5/R6<1.18.

6. The optical lens system as claimed in claim 1, wherein a central thickness of the fifth lens along the optical axis is CT5, a radius of curvature of the object-side surface of the fifth lens is R9, a radius of curvature of the image-side surface of the fifth lens is R10, and following condition is satisfied: −15.9 mm<CT5*(R9/R10)<1.81 mm

7. The optical lens system as claimed in claim 1, wherein the distance from the object-side surface of the first lens to the image plane along the optical axis is TL, the focal length of the optical lens system is f, and following condition is satisfied: 1.11<TL/f<1.88.

8. The optical lens system as claimed in claim 1, wherein the distance from the image-side surface of the sixth lens to the image plane along the optical axis is BFL, the distance from the object-side surface of the first lens to the image plane along the optical axis is TL, and following condition is satisfied: 0.15<BFL/TL<0.33.

9. The optical lens system as claimed in claim 1, wherein the distance from the stop to the image plane along the optical axis is TSI, the distance from the object-side surface of the first lens to the image plane along the optical axis is TL, the distance from the image-side surface of the sixth lens to the image plane along the optical axis is BFL, the focal length of the optical lens system is f, and following condition is satisfied: 0.28 mm⁻¹<TL/((TSI−BFL)*f)<0.47 mm⁻¹.

10. The optical lens system as claimed in claim 1, wherein a radius of curvature of the object-side surface of the fourth lens is R7, a radius of curvature of the image-side surface of the fourth lens is R8, and following condition is satisfied: 0.10<R7/R8<1.44.

11. The optical lens system as claimed in claim 1, wherein the focal length of the optical lens system is f, a radius of curvature of the image-side surface of the sixth lens is R12, a central thickness of the third lens along the optical axis is CT3, and following condition is satisfied: 3.88 mm⁻¹<f/(R12*CT3)<10.89 mm⁻¹.

12. The optical lens system as claimed in claim 1, wherein a central thickness of the sixth lens along the optical axis is CT6, a radius of curvature of the image-side surface of the sixth lens is R12, and following condition is satisfied: 0.27<CT6/R12<0.74.

13. The optical lens system as claimed in claim 4, wherein the focal length of the first lens is f1, the focal length of the optical lens system is f, and following condition is satisfied: −7.48<f1/f<1.98.

14. A photographing module, comprising:
a lens barrel,
an optical lens system disposed in the lens barrel, and
an image sensor disposed on an image plane of the optical lens system,
wherein the optical lens system, in order from an object side to an image side, comprising:
a first lens with refractive power, comprising an object-side surface and an image-side surface, the object-side surface of the first lens being convex near an optical axis, and at least one of the object-side surface and the image-side surface of the first lens being aspheric;
a second lens with refractive power, comprising an object-side surface and an image-side surface, and at least one of the object-side surface and the image-side surface of the second lens being aspheric;
a third lens with refractive power, comprising an object-side surface and an image-side surface, and at least one of the object-side surface and the image-side surface of the third lens being aspheric;
a fourth lens with refractive power, comprising an object-side surface and an image-side surface, and at least one of the object-side surface and the image-side surface of the fourth lens being aspheric;
a fifth lens with refractive power, comprising an object-side surface and an image-side surface, and at least one of the object-side surface and the image-side surface of the fifth lens being aspheric;
a sixth lens with refractive power, comprising an object-side surface and an image-side surface, the object-side surface of the sixth lens being convex near the optical axis and the image-side surface of the sixth lens being concave near the optical axis, and at least one of the object-side surface and the image-side surface of the sixth lens being aspheric and provided with an inflection point; and
an IR band-pass filter;
wherein a stop is disposed before the object-side surface of the first lens or between the image-side surface of the first lens and the object-side surface of the second lens, a distance from the stop to the image plane along the optical axis is TSI, a distance from the object-side surface of the first lens to the image plane along the optical axis is TL, a distance from the image-side surface of the sixth lens to the image plane along the optical axis is BFL, a focal length of the optical lens system is f, and following condition is satisfied: 0.25 mm⁻¹<TL/((TSI−BFL)*f)<0.49 mm⁻¹.

15. The photographing module as claimed in claim 14, wherein a focal length of the third lens is f3, a focal length of the fourth lens is f4, and following condition is satisfied: −1.93<f3/f4<0.62.

16. The photographing module as claimed in claim 14, wherein a focal length of the first lens is f1, the focal length of the optical lens system is f, and following condition is satisfied: −8.16<f1/f<2.15.

17. The photographing module as claimed in claim 14, wherein the distance from the image-side surface of the sixth lens to the image plane along the optical axis is BFL, the distance from the object-side surface of the first lens to the image plane along the optical axis is TL, and following condition is satisfied: 0.15<BFL/TL<0.33.

18. A photographing module, comprising:
a lens barrel,
an optical lens system disposed in the lens barrel, and
an image sensor disposed on an image plane of the optical lens system,
wherein the optical lens system, in order from an object side to an image side, comprising:
a first lens with refractive power, comprising an object-side surface and an image-side surface, the object-side surface of the first lens being convex near an optical axis, and at least one of the object-side surface and the image-side surface of the first lens being aspheric;
a second lens with refractive power, comprising an object-side surface and an image-side surface, and at least one of the object-side surface and the image-side surface of the second lens being aspheric;
a third lens with refractive power, comprising an object-side surface and an image-side surface, and at least one of the object-side surface and the image-side surface of the third lens being aspheric;
a fourth lens with refractive power, comprising an object-side surface and an image-side surface, and at least one of the object-side surface and the image-side surface of the fourth lens being aspheric;
a fifth lens with refractive power, comprising an object-side surface and an image-side surface, and at least one of the object-side surface and the image-side surface of the fifth lens being aspheric;
a sixth lens with refractive power, comprising an object-side surface and an image-side surface, the object-side surface of the sixth lens being convex near the optical axis and the image-side surface of the sixth lens being concave near the optical axis, and at least one of the object-side surface and the image-side surface of the sixth lens being aspheric and provided with an inflection point; and
an IR band-pass filter;
wherein a distance from the object-side surface of the first lens to the image plane along the optical axis is TL, half of an image height that can be captured by the optical lens system on the image plane is IMH, and following condition is satisfied: 1.4<TL/IMH<2.37.

19. The photographing module as claimed in claim 18, wherein a focal length of the first lens is f1, a focal length of the optical lens system is f, and following condition is satisfied: −8.16<f1/f<2.15.

20. The photographing module as claimed in claim 18, wherein a distance from the stop to the image plane along the optical axis is TSI, the distance from the object-side surface of the first lens to the image plane along the optical axis is TL, a distance from the image-side surface of the sixth lens to the image plane along the optical axis is BFL, a focal length of the optical lens system is f, and following condition is satisfied: 0.25 mm⁻¹<TL/((TSI−BFL)*f)<0.49 mm⁻¹.
